(19) United States
(12) Patent Application Publication
(10) Pub. No.: US 2010/0076731 A1
(43) Pub. Date: Mar. 25, 2010

(54) METHOD AND SYSTEM FOR DESIGNING A PASTRY

(75) Inventors: Scott Robert Fillman, Pottstown, PA (US); Tanna Marie Wagenmann Fillman, Pottstown, PA (US)

Correspondence Address: RATNERPRESTIA, P.O. BOX 980, VALLEY FORGE, PA, 19482, US

(73) Assignee: Topplestone, LLC, Pottstown, PA (US)

(21) Appl. No.: 12/609,588

(22) Filed: Oct. 30, 2009

Related U.S. Application Data
(63) Continuation-in-part of application No. 12/109,072, filed on Apr. 24, 2008.
(60) Provisional application No. 61/109,572, filed on Oct. 30, 2008.

(51) Int. Cl. G06F 17/50

(52) U.S. Cl. 703/1

(57) ABSTRACT

Method and systems for creating a pastry design are disclosed. The pasties are designed by receiving a tiers selection defining a number of pastry tiers; receiving a shape selection for each of the selected number of pastry tiers; presenting a pastry design based on the number of tiers selection and the shape selection for each of the number of pastry tiers; receiving decoration element inputs corresponding to one or more decoration elements; updating the presented pastry design with the one or more decoration elements responsive to the decoration element inputs; and storing the updated pastry design to a storage medium. A computer readable medium for performing the method is also disclosed.

### CROSS-REFERENCE TO RELATED APPLICATIONS

The present application claims priority from U.S. Provisional Patent Application Ser. No. 61/109,572, titled “System and Method for Designing a Pastry” and filed on Oct. 30, 2008, which is incorporated herein by reference, and from U.S. patent application Ser. No. 12/109,072, filed Apr. 24, 2008, which is incorporated fully herein by reference.

### FIELD OF INVENTION

This invention relates to pastry design and, more particularly, methods and systems for designing pastries.

### BACKGROUND OF THE INVENTION

Currently, when designing a specialty pastry, such as a wedding cake, many customers (e.g., brides) page through numerous magazines with cake photos illustrating various decorative elements. The customers provide photos illustrating desired elements along with suggested modifications to a pastry chef. The pastry chef then manually draws the cake to be made for the customer. The customer and the pastry chef may need to go through multiple design iterations before arriving at a final design, which can be time consuming and may be prohibitively expensive for some customers.

Consumers have an ever present desire for a less expensive and/or more expedient technique for designing consumer goods, such as specialty pastries. The present invention addresses this need, among others.

### BRIEF SUMMARY OF THE INVENTION

Briefly, the present invention provides a method for creating a pastry design. The method comprises the steps of receiving a tiers selection defining a number of pastry tiers; receiving a shape selection for each of the selected number of pastry tiers; presenting a pastry design based on the number of tiers selection and the shape selection for each of the number of pastry tiers; receiving decoration element inputs corresponding to one or more decoration elements; updating the presented pastry design with the one or more decoration elements responsive to the decoration element inputs; preparing an image for display; receiving image inputs corresponding to the image; updating the pastry design with the image; and storing the updated pastry design to a storage medium.

The present invention also provides a system for creating a pastry design comprising means for receiving a tiers selection defining a number of pastry tiers; means for receiving a shape selection for each of the selected number of pastry tiers; means for presenting a pastry design based on the number of tiers selection and the shape selection for each of the number of pastry tiers; means for receiving decoration element inputs corresponding to one or more decoration elements; means for updating the presented pastry design with the one or more decoration elements responsive to the decoration element inputs; means for preparing an image for display; means for receiving image inputs corresponding to the image; means for updating the pastry design with the image; and means for storing the updated pastry design to a storage medium.

Also, the present invention provides a method for designing a computer-generated floral bouquet. The method comprises the steps of receiving a frame selection identifying a frame; presenting the identified frame in a desired position on a video display; receiving a floral selection identifying a floral design; storing the floral bouquet design to a storage medium; recalling at least one of a plurality of user-generated floral bouquet designs from the storage medium; and adding the at least one of the plurality of user-generated floral designs to a pastry design.

### BRIEF DESCRIPTION OF THE FIGURES

The foregoing summary, as well as the following detailed description of exemplary embodiment of the invention, will be better understood when read in conjunction with the appended drawings, which are incorporated herein and constitute part of this specification. For the purposes of illustrating the invention, there are shown in the drawings exemplary embodiments of the present invention. It should be understood, however, that the invention is not limited to the precise arrangements and instrumentalities shown. In the drawings, the same reference numerals are employed for designating the same elements throughout the several figures. In the drawings:

FIG. 1 is a block diagram of an exemplary pastry design system in accordance with the present invention;

FIG. 2 is a flow diagram illustrating exemplary functionality for designing a pastry according to an aspect of the present invention;

FIG. 3 is a flow chart illustrating exemplary steps for designing a pastry according to another aspect of the present invention;

FIG. 4 is a flow chart illustrating exemplary steps for building a bouquet according to another aspect of the present invention;

FIG. 5 is a graphical user interface (GUI) of a welcome screen provided by an exemplary embodiment of the pastry design system of the present invention;

FIG. 6 is a GUI of a file dialogue box provided by an exemplary embodiment of the pastry design system of the present invention;

FIG. 7 is a GUI of a number of tiers selection screen provided by an exemplary embodiment of the pastry design system of the present invention;

FIG. 8 is a GUI of a three tier pre-configured tier and separator selection screen provided by an exemplary embodiment of the pastry design system of the present invention;

FIG. 9 is a GUI of a four tier pre-configured tier and separator selection screen provided by an exemplary embodiment of the pastry design system of the present invention;

FIG. 10 is a GUI of a five tier pre-configured tier and separator selection screen provided by an exemplary embodiment of the pastry design system of the present invention;

FIG. 11 is a GUI for selecting and configuring tiers and separators provided by an exemplary embodiment of the pastry design system of the present invention;

FIG. 11A is an alternative embodiment of a GUI for selecting and configuring tiers and separators provided by an exemplary embodiment of the pastry design system of the present invention;

FIG. 12 is a GUI for configuring the background provided by an exemplary embodiment of the pastry design system of the present invention;

FIG. 13 is a GUI of for configuring tier options provided by an exemplary embodiment of the pastry design system of the present invention;

FIG. 13A is a GUI of a three-dimensional objects color palate for the tiers shown in FIG. 13 provided by an exemplary embodiment of the pastry design system of the present invention;

FIG. 14 is a GUI for selecting and configuring decoration elements provided by an exemplary embodiment of the pastry design system of the present invention;

FIG. 14A is a GUI of a decorations color palate provided by an exemplary embodiment of the pastry design system of the present invention;

FIG. 14B is a GUI of a clone/duplicate number selection box for a decoration provided by an exemplary embodiment of the pastry design system of the present invention;

FIG. 14C is a GUI of a enter/edit text dialogue box provided by an exemplary embodiment of the pastry design system of the present invention;

FIG. 14D is a GUI of a text attribute editor provided by an exemplary embodiment of the pastry design system of the present invention;

FIG. 14E is a GUI of a decorations menu provided by an exemplary embodiment of the pastry design system of the present invention;

FIG. 15 is a GUI for selecting and configuring flowers including a bouquet builder and associated options provided by an exemplary embodiment of the pastry design system of the present invention;

FIG. 15A is a GUI of a flower menu provided by an exemplary embodiment of the pastry design system of the present invention;

FIG. 15B is a GUI of a flower specific color palate provided by an exemplary embodiment of the pastry design system of the present invention;

FIG. 15C is a GUI of a bouquet builder color palate provided by an exemplary embodiment of the pastry design system of the present invention;

FIG. 16 is a GUI for selecting and configuring toppers provided by an exemplary embodiment of the pastry design system of the present invention;

FIG. 16A is a GUI of a Bride and Groom color palate provided by an exemplary embodiment of the pastry design system of the present invention;

FIG. 16B is a GUI of a three-dimensional monogram color palate provided by an exemplary embodiment of the pastry design system of the present invention;

FIG. 17A is a GUI of a “File” drop down menu provided by an exemplary embodiment of the pastry design system of the present invention;

FIG. 17B is a GUI of an “Edit” drop down menu provided by an exemplary embodiment of the pastry design system of the present invention;

FIG. 17C is a GUI of a “Select Mask” drop down menu provided by an exemplary embodiment of the pastry design system of the present invention;

FIG. 17D is a GUI of an “Add” drop down menu provided by an exemplary embodiment of the pastry design system of the present invention;

FIG. 18 is a GUI of a print screen data entry dialogue box provided by an exemplary embodiment of the pastry design system of the present invention;

FIG. 18A is a GUI of a “File” drop down menu provided by an alternative embodiment of the pastry design system of the present invention;

FIG. 19 is a GUI depicting an exemplary finished product provided by an exemplary embodiment of the pastry design system of the present invention;

FIG. 20 is a GUI of an “Enter Bouquet Name” dialogue box provided by an exemplary embodiment of the pastry design system of the present invention;

FIG. 21 is a GUI for selecting a desired decoration provided by an exemplary embodiment of the pastry design system of the present invention;

FIG. 22 is a GUI of an “Import New Decal” preparation dialogue box provided by an exemplary embodiment of the pastry design system of the present invention;

FIG. 23 is a GUI of an “Import New Decal” import dialogue box provided by an exemplary embodiment of the pastry design system of the present invention;

FIG. 24 is a GUI of the “Import New Decal” import dialogue box of FIG. 23, with a “Choose Decal Bitmap” dialogue box provided by an exemplary embodiment of the pastry design system of the present invention;

FIG. 25 is GUI of an “Import New Decal” preview dialogue box provided by an exemplary embodiment of the pastry design system of the present invention;

FIG. 25A is a GUI of the decal illustrated in FIG. 25, having been placed on a pastry design;

FIG. 26 is a GUI of a Library menu provided by an exemplary embodiment of the pastry design system of the present invention;

FIG. 27 is a GUI of a list of bouquet files available for importation provided by an exemplary embodiment of the pastry design system of the present invention;

FIG. 28 is a GUI of a “Select Mask” drop down menu provided by an alternative exemplary embodiment of the pastry design system of the present invention;

FIG. 29 is a flow chart illustrating exemplary steps for importing an image according to another aspect of the present invention; and

FIG. 30 is a flow chart illustrating exemplary steps for exporting and importing a bouquet according to another aspect of the present invention.

### DETAILED DESCRIPTION OF THE INVENTION

Although the invention is illustrated and described herein with reference to a specific embodiment, the invention is not intended to be limited to the details shown. Rather, various modifications may be made in the details within the scope and range of equivalents of the claims and without departing from the invention. The invention is best understood from the following detailed description when read in connection with the accompanying figures, which show an exemplary embodiment of the invention selected for illustrative purposes. The invention will be illustrated with reference to the figures. Such figures are intended to be illustrative rather than limiting and are included herewith to facilitate the explanation of the present invention.

Generally, the present invention includes a pastry design system that may be used to design a pastry, such as a wedding cake or other specialty cake, on a computer. This system is useful to anyone who would like to design his/her own cake, for example. Exemplary embodiments of the system allow the user to select various parameters for decorating the pastry, such as shape and number of tiers, the number and types of decorations, and other features that are typically added to a specialty pastry, which are described in detail below. The system may also allow the user to view and rotate the design in three dimensions in order to give the user a better appreciation of how the finished pastry will look. Design packages may be added to the system to provide additional design elements from which to choose when designing the pastry. The pastry design may be saved and downloaded in various formats including, but not limited to, hard copy (paper), a conventional format such as the joint photographic experts group (.jpg) format, or a proprietary format such as a wedding cake design pro (.wcd) format, e.g., for later use by a third party, such as a baker.

During the cake design process, the user may select from a pre-configured tier and separator set or construct a tier and separator combination from scratch, adjusting each tier and component individually for shape, size, rotation, number, height, width, including the ability to undo and/or delete features. Once selected, the pre-configured tier and separator stacks may be manipulated similarly. The system also walks the user through the construction process via a “When you've finished, Proceed to Next Step” icon.

In an exemplary embodiment, the inventive pastry design system may be a stand-alone system that, once installed, may be enhanced with periodic upgrades and additions to the graphics files or other application file attributes. In another embodiment, the inventive pastry design system may be supported on a server, and accessed remotely by one or more users, such as through a global information network (the Internet), an Intranet, or other remotely accessible systems.

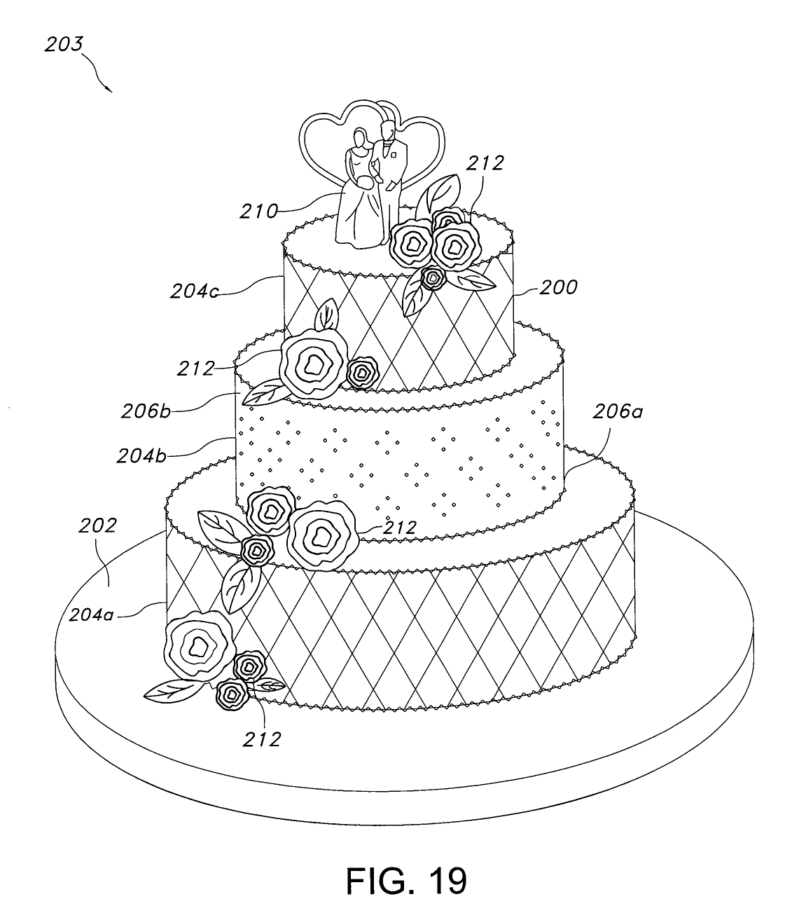

FIG. 19 depicts an exemplary pastry design for a cake 200 created using a system in accordance with the present invention. Cake 200 is depicted on plate 202 set against a colored background 203. Cake 200 includes a plurality of tiers (three tiers 204a-204c in the illustrated embodiment). Lower tier 204a and middle tier 204b are each decorated with a plurality of different decoration elements (such as beading 206a and decorative dots 206b). A cake topper 210 is positioned on the top of top tier 204c. Representations of live floral bouquets 212 are illustrated on each tier 204a-204c as well as on plate 202.

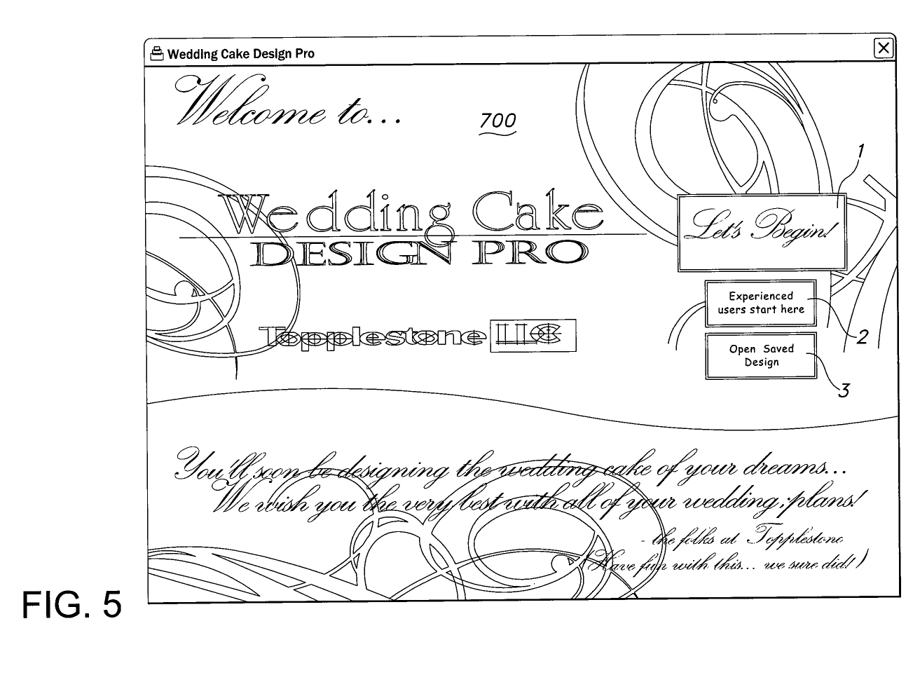

The exemplary GUIs depicted in FIGS. 5-18 and described in detail below present the cake 200 that is being designed on a plate 202 that rests on a removable table (not shown) against a background 203. The displayed cake table, plate 202, and cake 200 may be rotated 360 degrees and may be tilted in any direction for viewing at multiple angles, including a top-down or overhead view.

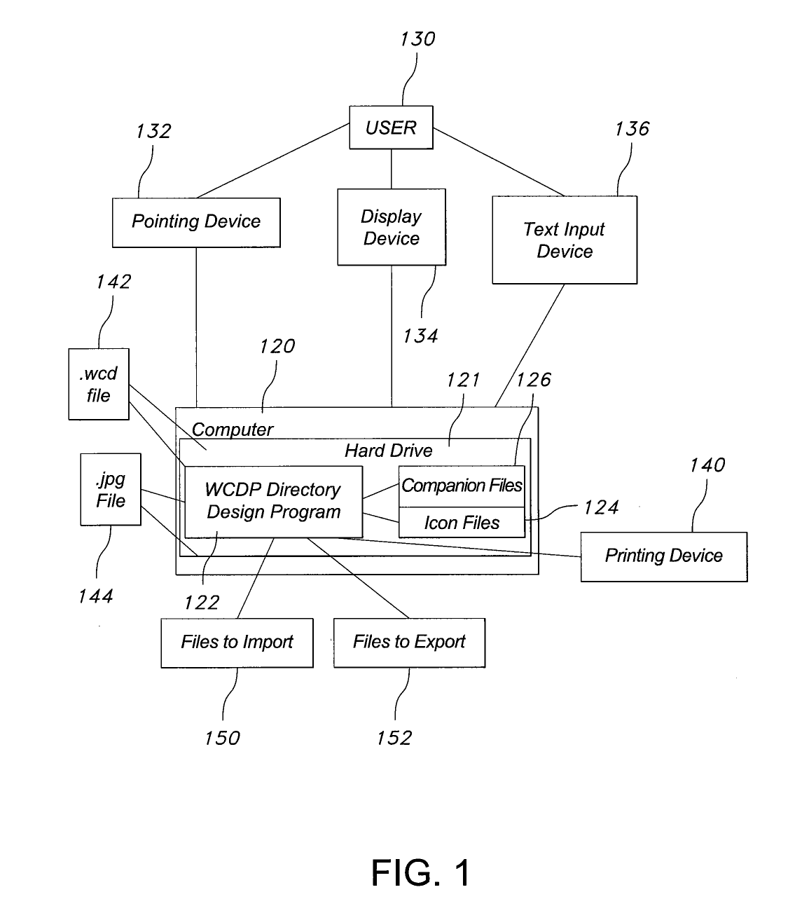

FIG. 1 depicts an exemplary computer system on which the pastry design system of the present invention may reside for creating a pastry design such as depicted in FIG. 19. The illustrated computer system includes a computer 120 having a hard drive 121. The pastry design system is stored on hard drive 121, e.g., within a “wedding cake design pro” (.wcdp) system directory 122 along with a three-dimensional display engine (not shown), associated icon files 124, and companion files 126.

The computer system further includes a pointing device 132, such as a mouse, a display device 134, such as a monitor, and a text input device 136, such as a keyboard. An optional printing device 140 associated with the computer is provided for printing pastry designs. A user 130 may provide input information to the computer via the pointing device 132 and text input device 136. Selections and controls in the GUI described below may be operated with the pointing device 132 using techniques such as click, drag, drop; click-and-hold button; and click-and-hold button slide functionality that are well-known to computer users.

The icon files 124 may be associated with .wcdp directory 122 and are used by the computer system as instructed by the pastry design system to generate icons for navigation/selection controls depicted in the GUIs described below, e.g., to allow user 130 to navigate through the GUIs and make selections more easily. Companion files 126 may also be associated with .wcdp directory 122 and include three-dimensional and/or two-dimensional graphics/decoration files that user 130 encounters on display 134 and that may be applied to the tiers, bouquet builders, and other objects as described in further detail below. The tiers, separators, color palates, and other objects described below may be included in these files. As used herein, both two-dimensional and three-dimensional decorations may be rotated, spun, and tilted.

A system file 142, such as a “wedding cake design” (.wcd) file, can be saved to computer hard drive 121 in .wcdp directory 122, or other storage device (internal or external). Further, a conventional file type 144, such as .jpg, can be saved to computer hard drive 121, e.g., in .wcdp directory 122, or other storage device (internal or external).

Files may be imported 150, which may be .gif/.jpg/ portable networks graphics (.png) files, for example, and files may be exported 152, such as a preliminary or finished pastry design files, which may be portable document format (.pdf)/.xml/tab-delimited files, for example. A user may import decorations and/or collections of decorations for placement on a pastry. The decorations or collections of decorations may be generated and stored in various file formats which may include but are not limited to .png, .pdf, .jpg, three-dimensional design programs such as AC3D, virtual reality modeling language (Vrml) file formats. These decorations/collections may be wrapped in a conventional installer that, when executed, places the decorations/collections and their control files in the appropriate directories. Alternatively, these decorations/collections may be images that are licensed and formatted for integration into the system. Examples of a licensed image may include, but are not limited to, Donald Duck, Scooby Doo, the Harley Davidson logo, or a likeness of Elvis Presley. A user may also create/edit and store decorations and/or collections of decorations as well as manipulate those decorations/collections, which can be recalled for later use. The development of an appropriate installer will be understood by one of skill in the art from the description herein.

Partial and completed designs may be saved in a conventional format such as .jpg or in a proprietary file format such as a .wcd file. The .wcd files may be reloaded for continued work or viewing or exchanged with another user who has a compatible pastry design system. Such a feature may be especially beneficial to a baker, who may be able to load a .wcd file received from a customer in order to view and rotate the customer's design.

A .jpg file saved with a particular name may be overwritten to reflect changes made to the .wcd file. An example of this would be a single cake tier with the letter “A” on the top that is rendered and saved as a .wcd file and given a name, such as, but not limited to “a cake tier” (e.g., a cake tier.wcd). This file can also be saved as a .jpg file (a cake tier.jpg). The user may recall the .wcd file and make changes to the .wcd file and save the new design as the same file name, such as “a cake tier.wcd” and/or “a cake tier.jpg” with the changes. Alternatively, the user may rename the file to any name the user desires.

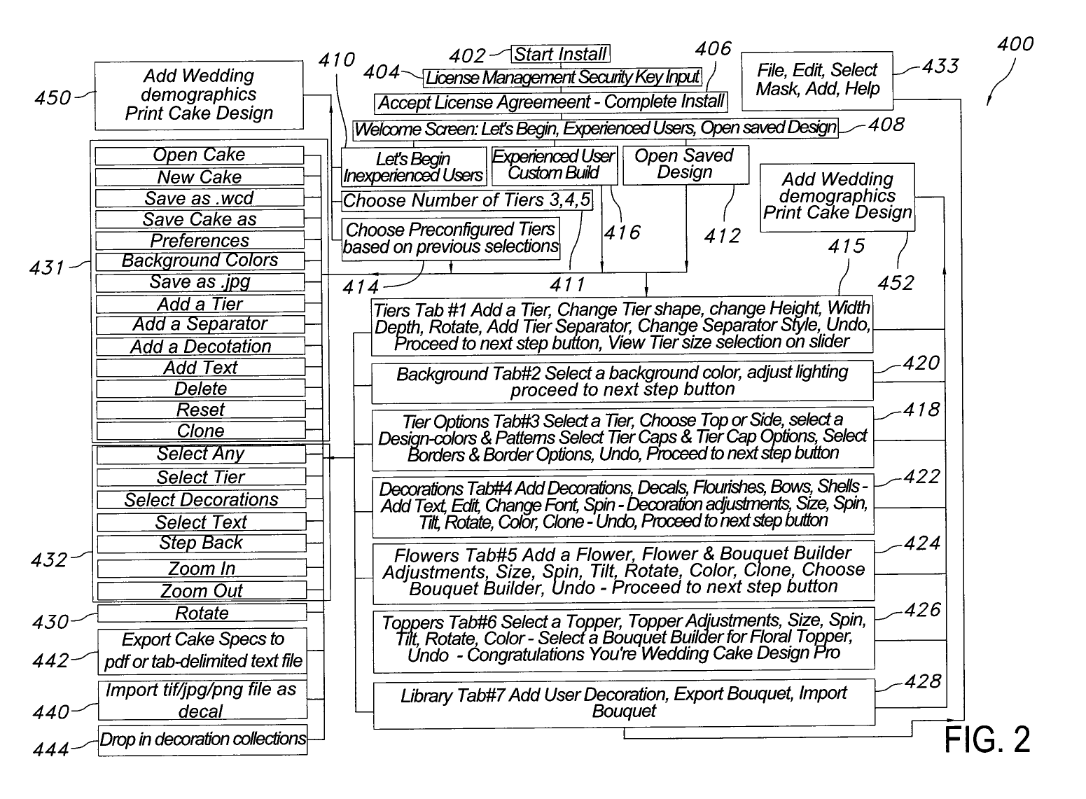

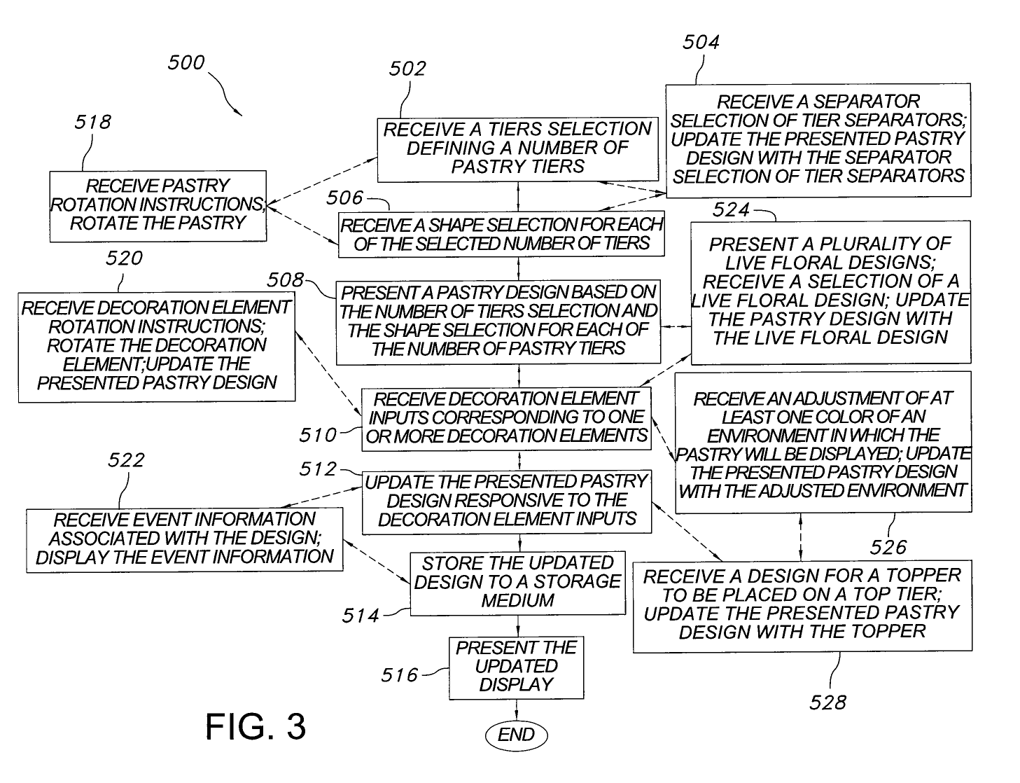

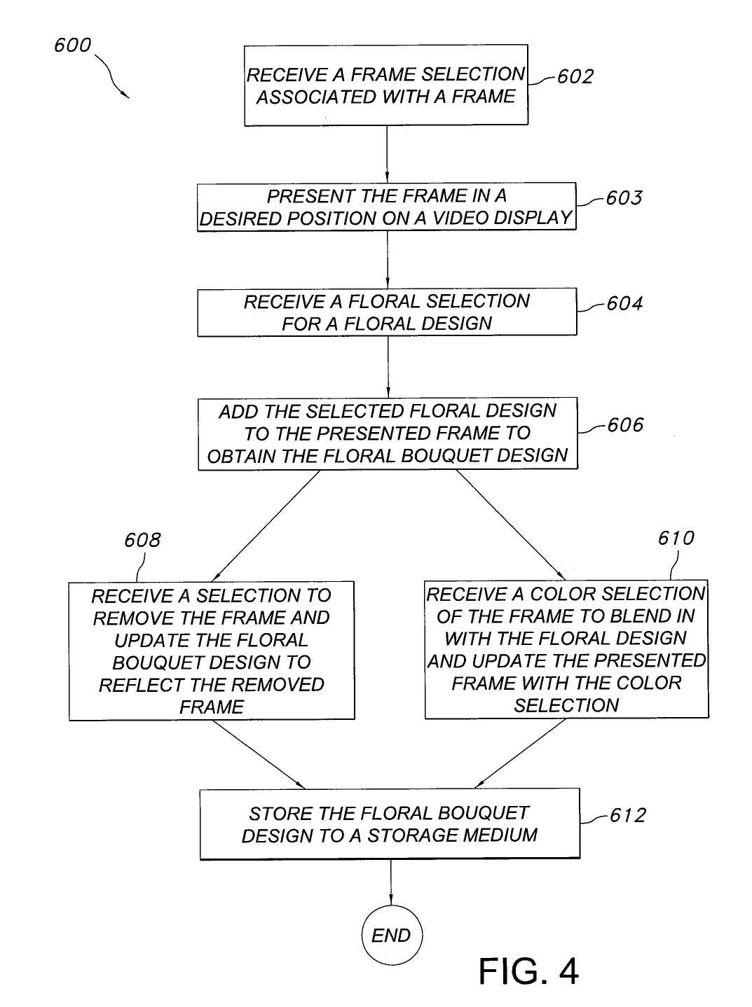

Exemplary embodiments of the pastry design system according to the present invention are described below with reference to the flow diagram of FIG. 2, the flow charts of FIGS. 3 and 4, and the GUIs of FIGS. 5-28.

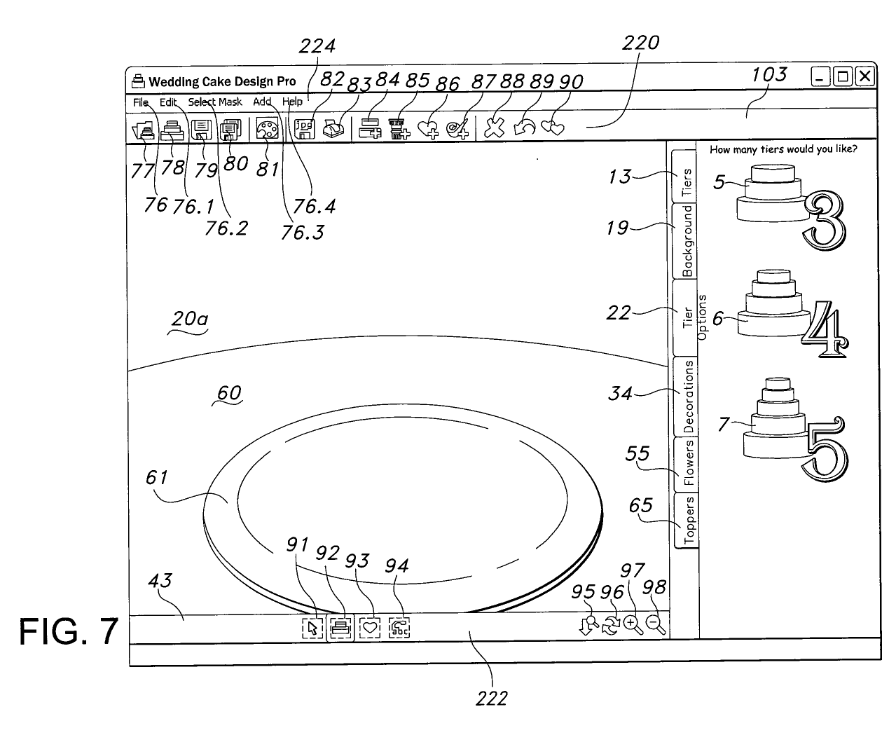

FIG. 2 depicts a flow diagram 400 for use in describing installation of the pastry design system (BLOCKs 402-406), a welcome sequence (BLOCKs 408-416), flow between the various GUIs described below with reference to FIGS. 7-28 (BLOCKs 415-428), and various functionality provided by these GUIs (BLOCKs 431-452).

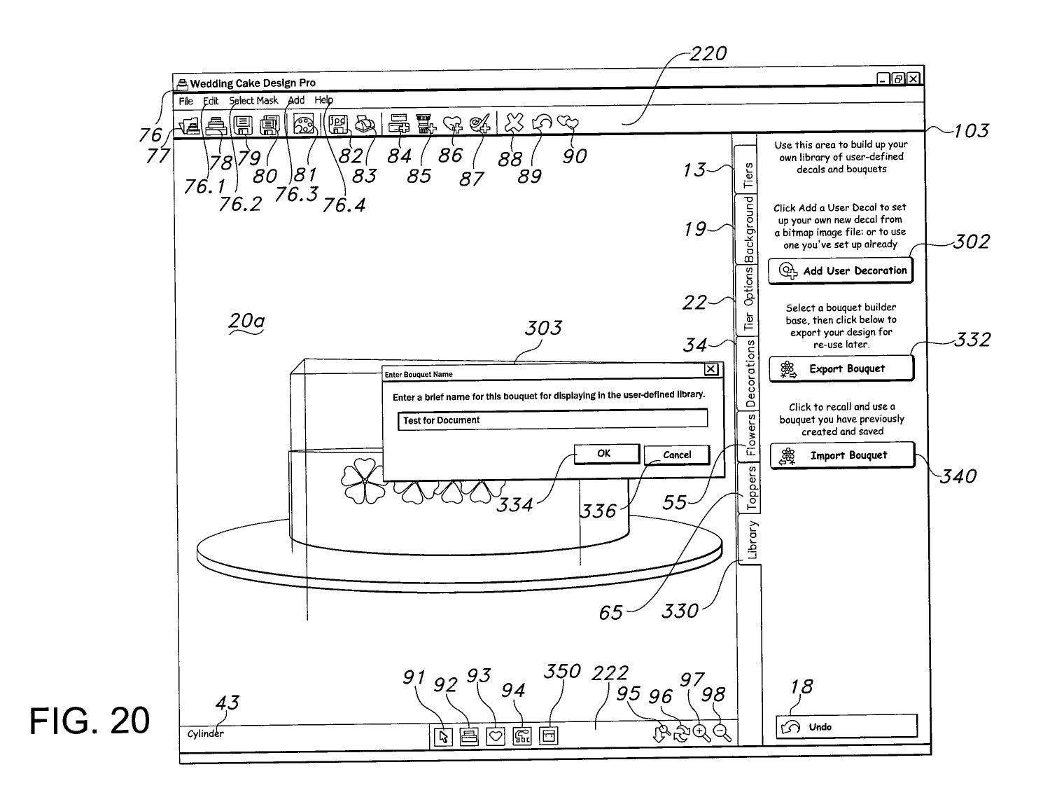

The illustrated system is organized in the manner in which cakes are typically built and decorated in a physical pastry shop. BLOCKs 415, 420, 418, 422, 424, 426 illustrate functionality associated with Tier tab 13, Background tab 19, Tier Options tab 22, Decorations tab 34, Flowers tab 55, Toppers tab 65, and Library Tab 330 (Library tab 330 shown only in FIGS. 20, 22-26, and 28), respectively, of the GUIs depicted in FIGS. 7-28. These tabs guide the user through the construction and decoration process necessary to complete a cake. Referring to FIG. 2, the lines interconnecting BLOCKS 415, 420, 418, 422, 424, 426, and 428 with one another indicate that the functionality associated with these blocks may be accessed at any time, and in any order.

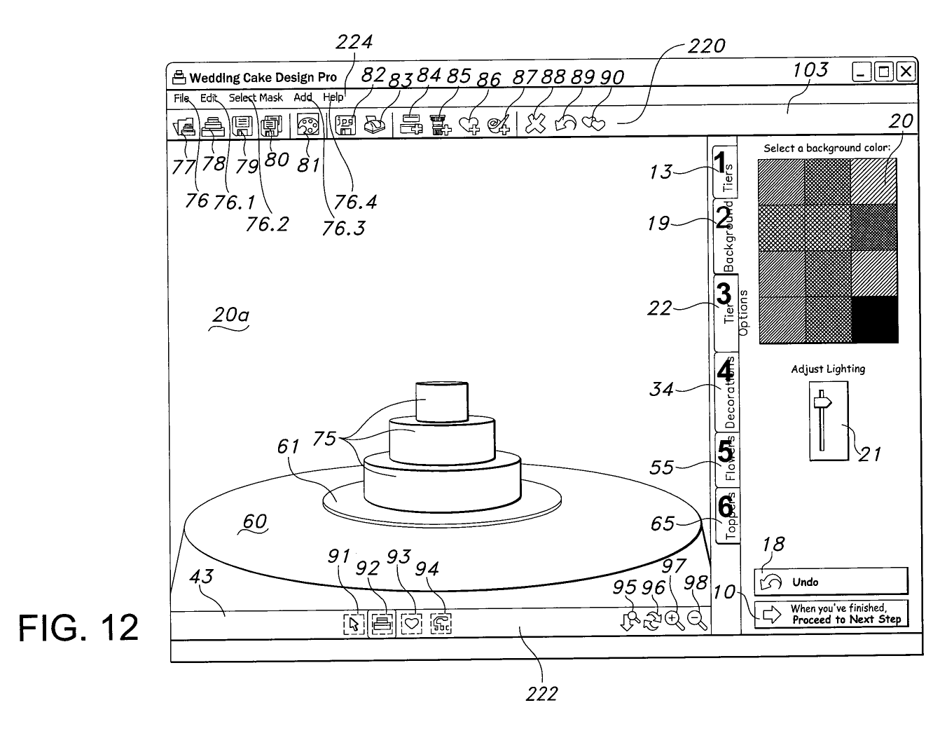

The system is flexible in that, from any point on a design screen, the user may select any tab 13, 19, 22, 34, and 55 (see, for example, the GUI depicted in FIG. 7) to access the functionality of any of BLOCKS 415, 420, 418, 422, 424, 426 associated with that tab. Referring to FIGS. 12-14, 14B-14D, 15A-16, and 17, a tool panel 103 includes “Undo” icon 18 and “When you're finished, proceed to the next step” icon 10 to assist the user in navigating forward and backward through the pastry design system, while FIGS. 20, 22-26, and 28 include only “Undo” icon 18. Selection of “Undo” icon 18 undoes the previous step. Selection of “When you're finished, proceed to the next step” icon 10 prompts the pastry design system to perform the next step. For example, if the user is presently viewing a GUI associated with the first tab, this selection will result in a GUI associated with the second tab being displayed. The functionality associated with BLOCKS 415, 420, 418, 424, and 426 will be described in greater detail below.

The installation flow depicted in FIG. 2 is now described. The pastry design software is installed onto a resident computer, such as a PC or laptop, at BLOCK 402. In an exemplary embodiment, a user is required to input security key information in BLOCK 404 in order to reduce the likelihood of pirating the pastry design system. The user may then be required to accept a license agreement in BLOCK 406 in order to complete the installation and begin using the system.

A language may be selected during installation of the pastry design system for use during operation of the pastry design system. The user may select from available languages in order to facilitate ease of use. In an exemplary embodiment, languages that are available for selection may be English, Spanish, Portuguese, Japanese, and Italian. Other languages may be used as well.

The welcome sequence depicted in FIG. 2 is now described. In BLOCK 408, a welcome screen is displayed. In an exemplary embodiment, the welcome screen provides the user with a choice of the following options: (for beginners) “Let's begin” and (for more experienced users) “Experienced Users” or “Open Saved Design.” FIG. 5 depicts an exemplary GUI 700 for use as the welcome screen GUI. GUI 700 includes three choices for the user: “Lets' Begin” icon 1, “Experienced users start here” icon 2, and “Open Saved Design” icon 3.

Upon selecting “Lets' Begin”, the pastry design system moves to BLOCK 410. Upon selecting “Experienced users start here”, the pastry design system moves to BLOCK 416. Upon selecting “Open Saved Design”, the pastry system moves to BLOCK 412.

BLOCK 410 is reached when a user selects “Let's Begin”, e.g., by selecting “Let's Begin” icon 1 (FIG. 5) with a pointing device 132 (FIG. 1). In response to selecting icon 1, a first pre-configured tiers GUI, such as shown in FIG. 7, is displayed. FIG. 7 includes a cake background 20a. Three tier icons are displayed in FIG. 7 that represent the number of tiers that the user may select: a three-tier icon 5, a four-tier icon 6, and a five-tier icon 7. In BLOCK 411, the user selects the number of desired tiers, e.g., by selecting the desired tier icon on the pre-configured tiers GUI (FIG. 7).

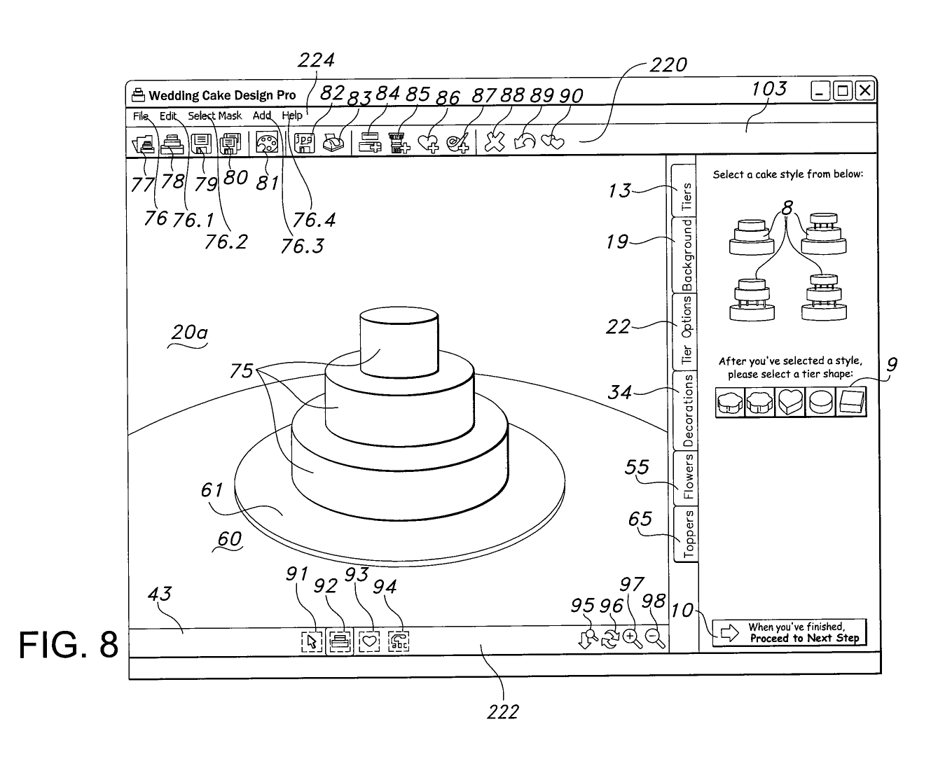

When three-tier icon 5 is selected, the pastry design system presents a pre-configured tiers GUI for the three tiers, shown in FIG. 8. The tool panel 103 in FIG. 8 includes multiple combinations/styles 8 of pre-configured tiers and separators for cakes with three tiers. In the illustrated embodiment, four combinations 8 are shown. The pre-configured tiers may be stored within the pastry design system, e.g., in the .wcdp directory. As illustrated by BLOCK 414, selecting one of the combinations 8 shown in tool panel 103 displays the selected combination on plate 61 (in this case the upper left combination).

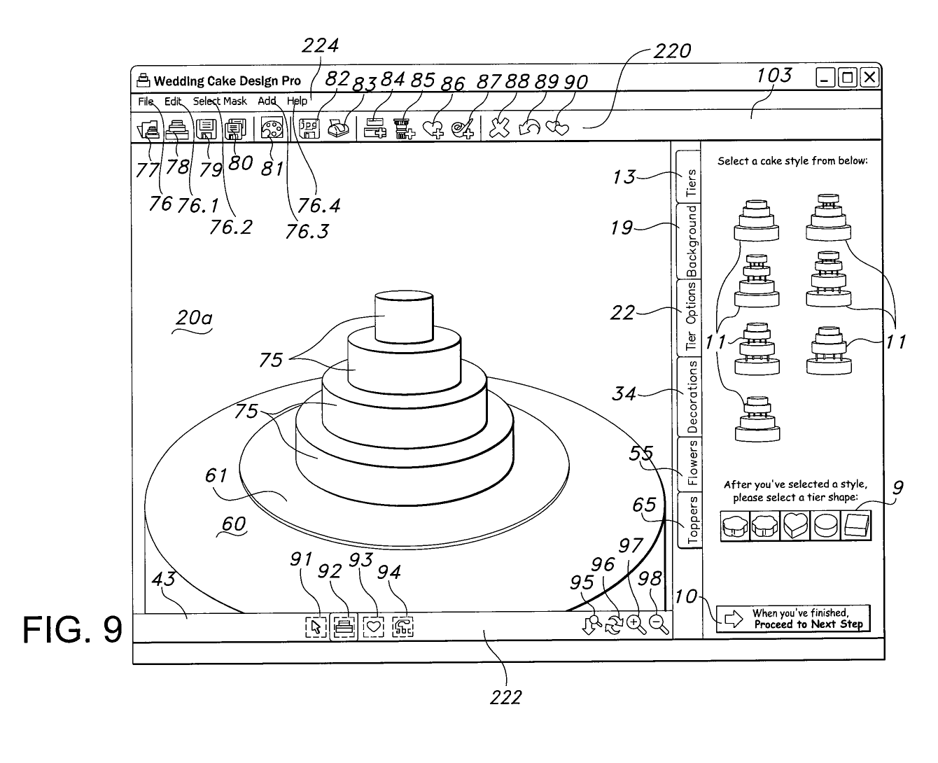

When four-tier icon 6 is selected, the pastry design system presents the pre-configured tiers GUI for four tiers (FIG. 9). The tool panel 103 in FIG. 9 includes multiple combinations/styles 11 of pre-configured tiers and separators for cakes with four tiers. In the illustrated embodiment, seven combinations are shown. The pre-configured tiers may be stored within the pastry design system, e.g., in the .wcdp directory. As illustrated by BLOCK 414, selecting one of the combinations 11 shown in tool panel 103 displays the selected combination on plate 61 (in this case the upper left combination).

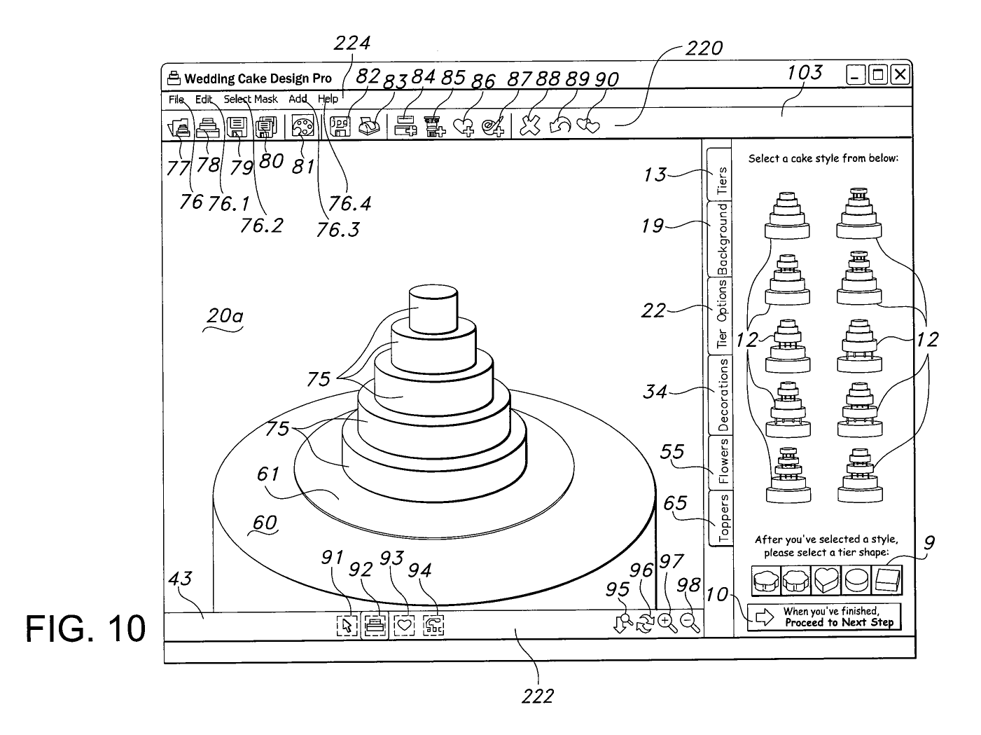

When five-tier icon 7 is selected, the pastry design system presents the pre-configured tiers GUI for five tiers (FIG. 10). The tool panel 103 includes multiple combinations 12 of pre-configured tiers and separators for cakes with five tiers. In the illustrated embodiment, ten combinations are shown. The pre-configured tiers may be stored within the pastry design system, e.g., in the .wcdp directory. As illustrated by BLOCK 414, selecting one of the combinations 12 shown in tool panel 103 displays the selected combination on plate 61 (in this case the upper left combination).

In any one of the three-tier, four-tier, or five-tier arrangements, the shape of each tier may be adjusted by clicking shape icon 9 (FIGS. 8-10) associated with the desired shape.

In an exemplary embodiment, if the user selects “When you've finished, Proceed to Next Step” icon 10, the pastry design system presents the GUI illustrated in FIG. 12, which provides the functionality associated with BLOCK 420.

Located at the bottom of tool panel 103 on each of the pre-configured tier screens shown in FIGS. 8-10 is a “Proceed to the Next Step” icon 10. On tool panel 103, icons 9 may be used to change the shape of a selected tier. As discussed above with reference to FIGS. 8-10, five tier shapes are disclosed. Those skilled in the art, however, will recognize that alternative and/or additional tier shapes may be displayed and selected.

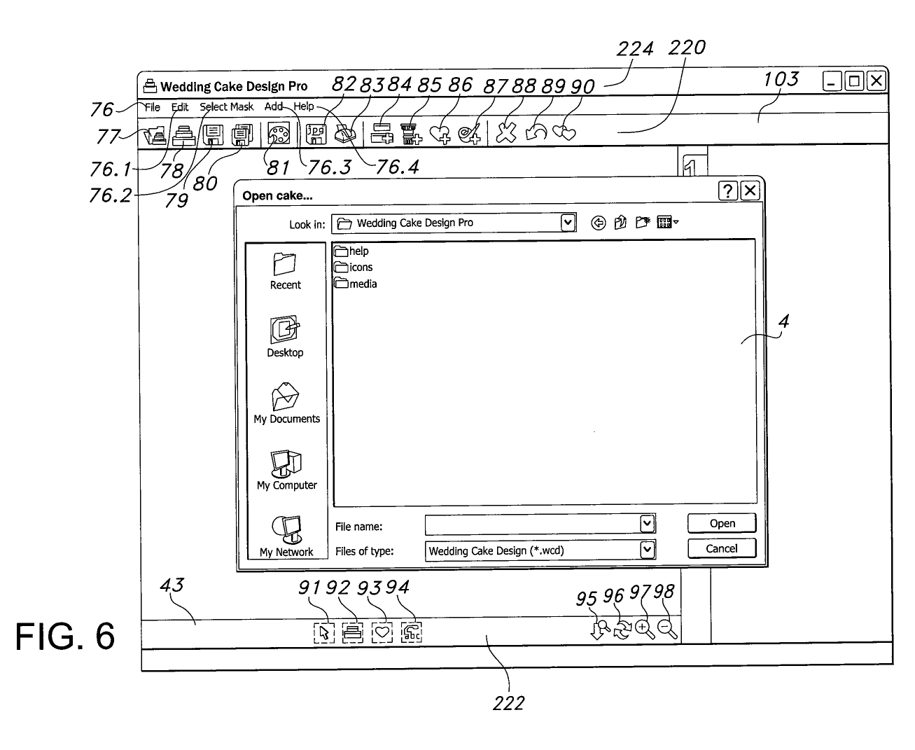

BLOCK 412 is reached when a user selects to open a previously saved design, e.g., by selecting “Open Saved Design” icon 3 (FIG. 5). In an exemplary embodiment, this selection prompts the pastry design system to display the GUI depicted in FIG. 6. The GUI depicted in FIG. 6 contains a dialogue box 4 that the user may use to recall a previously saved design. For example, the user may enter the name of the saved design into the file name area of the dialogue box 4 and select “open.” The saved design is recalled from a default directory location. The pastry design system then displays a GUI, such as the GUI shown in FIG. 7, with the saved cake design placed on the cake plate 61 on a table 60 in front of the background 20a.

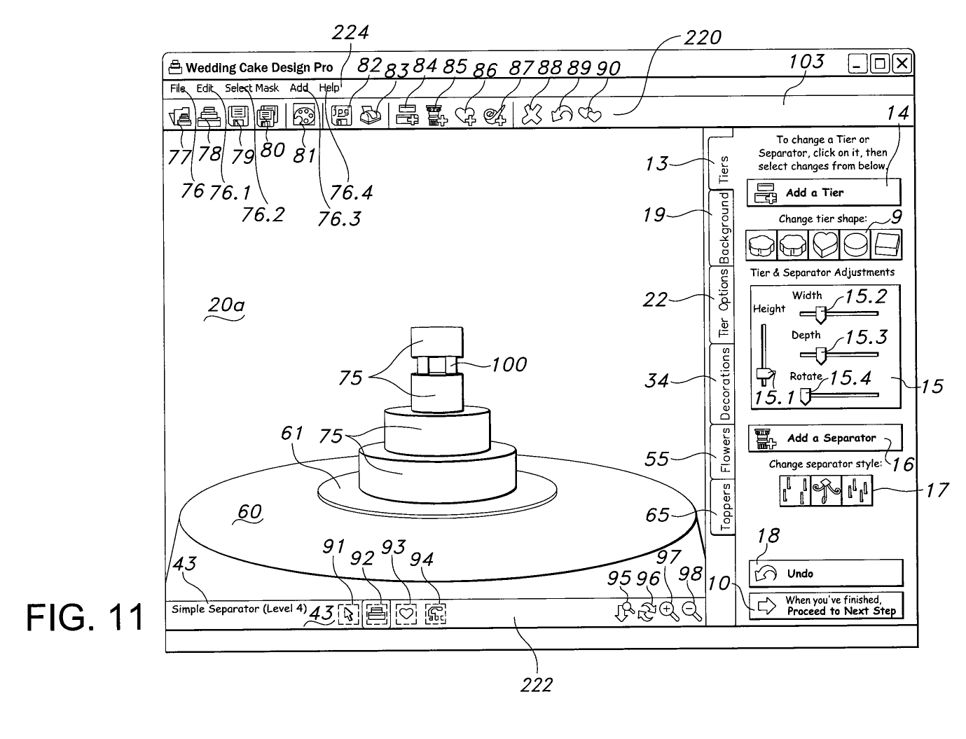

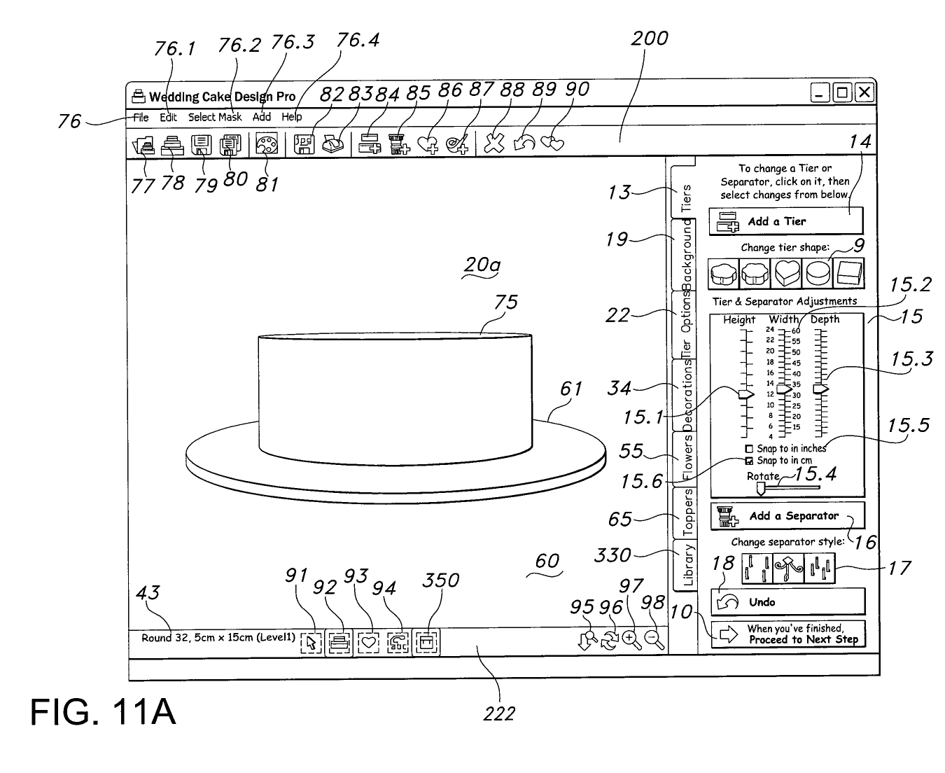

BLOCK 416 is reached when a user selects to proceed as an “experienced” user, e.g., by selecting “Experienced users start here” icon 2. When icon 2 is selected in BLOCK 416, the pastry design system presents the GUI shown in FIG. 11, which is associated with the functionality of BLOCK 415. In the GUI depicted in FIG. 11, the background 20a may initially contain an empty table 60 and an empty cake plate 61. FIG. 11 illustrates four tiers 75 having already been added to plate 61, along with a separator 100 between the top two tiers.

The user may select “Add a Tier” 14, which will place a tier on cake plate 61. The tier defaults to a round shape, which may be modified as discussed in more detail below by selecting an appropriate icon from “Change tier shape” 9. Changes in height, width, depth, and rotation may be made to the selected tier by adjusting sliders 15.1-15.4 displayed on a slider selection panel 15. The user may also add tier separators by selecting “Add a Separator” icon 16 or change the tier separator style by selecting separator style icon 17 corresponding to the desired style. The presented pastry design is then updated with the separator selection. After a tier separator is added, the user may change the height, width, and rotation of the separator by navigating to the tiers tab 13 and then using adjustment sliders 15.1-15.4.

Optionally, sliders 15.1-15.4 may include size indicia. In an exemplary embodiment, shown in FIG. 11A, while inches and centimeters are marked off on only “Width” slider 15.2, those skilled in the art will recognize that the remaining sliders 15.1 and 15.3 may also include the same, or different indicia.

To adjust the dimensions of either tier 75 or separator 100 (only tier 75 shown in FIG. 11A), the user may select “Snap to in inches” or “Snap to in centimeters” by selection of either radio control button 15.5 or button 15.6.

When the user selects either button 15.5 or 15.6 and then clicks on a tic mark or on a number on the slider scale, the preselected tier/separator which is being worked on by the user, automatically “snaps” to that size and the corresponding slider 15.1-15.3 “snaps” to that location on the slider scale.

When the user selects either “Snap to Inches” or “Snap to cm,” the slider indicator points to either the inch side of the scale or the centimeter side of the scale depending on which form of measurement is selected. Additionally, the dimensions of the selected tier 75 or separator 100 are displayed as a read out on a lower horizontal tool bar 222.

In BLOCK 430, the user may provide instructions to rotate the design. The design may be rotated about a vertical axis, e.g., by right-clicking and holding a mouse, sliding the mouse to the right for design rotation in a first direction, or sliding the mouse to the left for design rotation in an opposing direction. The design may be rotated about a horizontal axis, e.g., by right-clicking and holding the mouse, sliding the mouse downward to tilt the top of the design toward the user, or alternatively, by right-clicking and holding the mouse sliding the mouse upward to tilt the bottom of the design toward the user.

During the decoration process, the user may access tool icons 77-90 (see, for example, the GUI depiction in FIG. 11) from an upper horizontal tool bar 220, which correspond to the functionality in BLOCK 431, tool icons 91-98 from lower horizontal tool bar 222 which correspond to the functionality in BLOCK 432, and tool icons 76-76.4 from a command tool bar 224, which correspond to the functionality in BLOCK 433. Selecting icon 76 on the upper horizontal tool bar 220 or either of icons 79, 80 on the command tool bar 224 prompts the pastry design system to save the current pastry design, e.g., as a .wcd file or a .jpg file. The .wcd and .jpg files by default are stored in the .wcdp directory 122, shown in FIG. 1. The .wcd file may be recalled at a later date in order to continue working on a project or shared with another party who has a compatible pastry design system. That party may then recall the file and view or make changes to the pastry design.

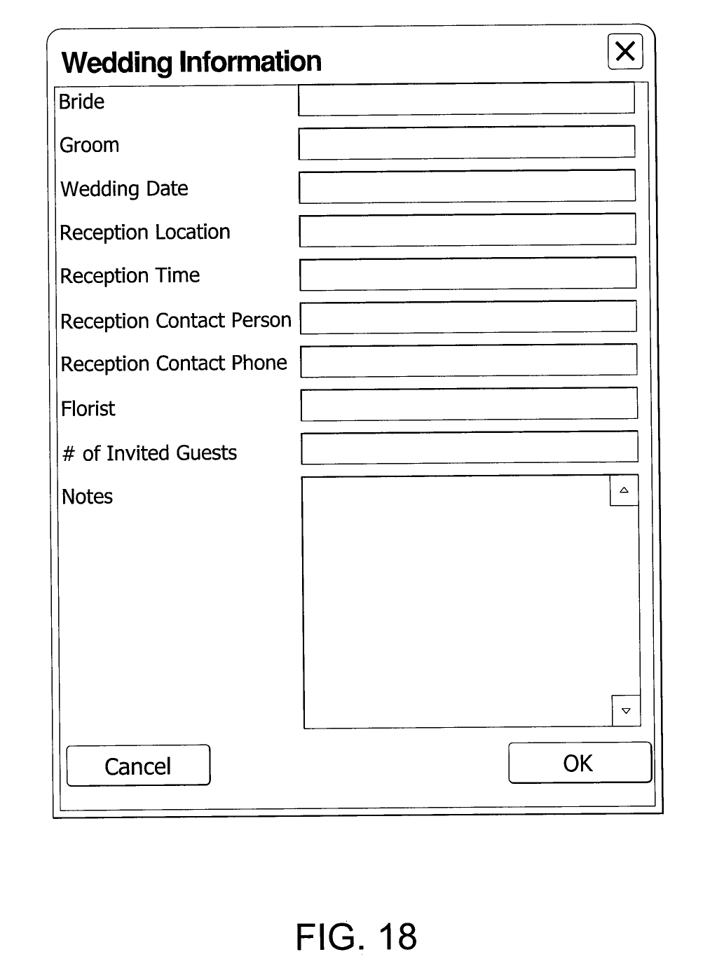

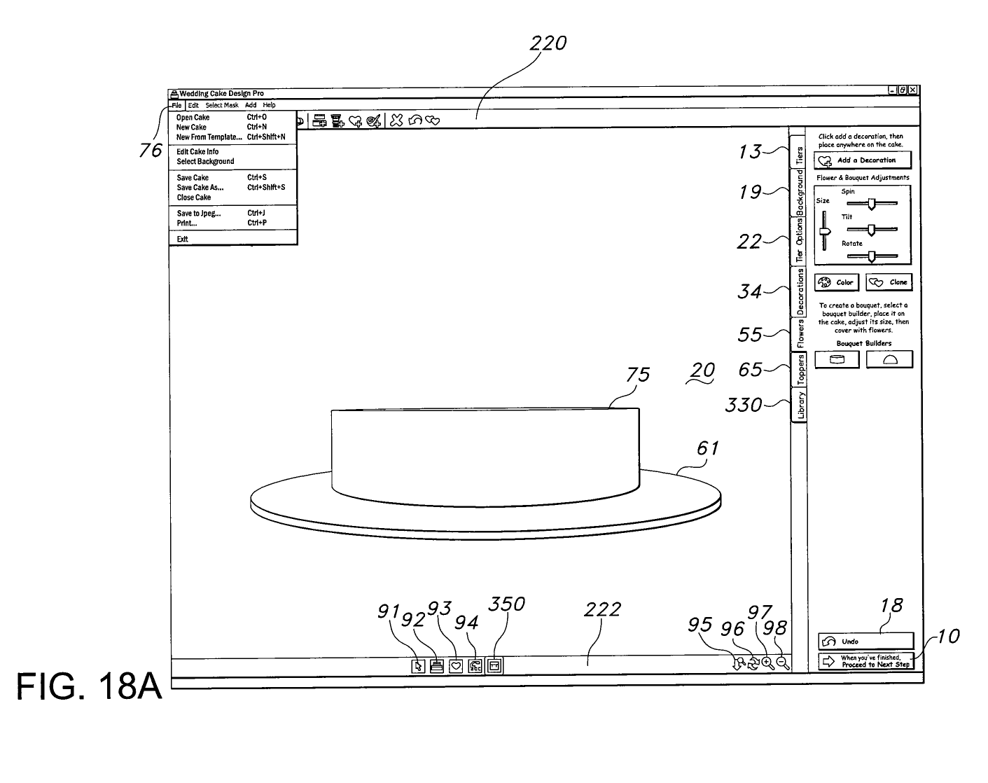

At any time during the design process, the pastry design may be saved to the computer hard drive 121 (FIG. 1) or to another data storage device in the form of the re-loadable .wcd file. The .jpg and print formats display the design in two dimensions. If the print option is selected, the functionality of BLOCKS 450 and 452 is accessed with a demographic form GUI (FIG. 18), being displayed that allows the user to input special occasion information associated with the design, such as, but not limited to, number of guests, location, time, date of the event, and notes. If desired, in an exemplary embodiment, this information may be displayed by printing the information in the lower left hand corner of the picture or the designed cake. The information is helpful to florists and party planners as well as chefs and others.

The user may also edit this information at any time by selecting the “File” icon 76 from command line 224 and then selecting the “Edit Cake Info” from dropdown box 76, which is shown in FIG. 18A. The user may then make changes to the information contained in demographic dialogue box 99. This information is then saved by clicking “OK”, which closes demographic dialogue box 99.

Once the tiers are constructed, the user may customize each tier by changing color and/or patterns and adding “caps.” As used herein, a cap may include design elements and/or options that are the computer graphic design equivalent to rolled fondant tier overlays with various distal edge configurations. Alternatively, a cap may represent an actual cloth “hanky” overlay. The user may further customize each tier by adding decorative elements such as borders, flowers, bouquets, people, and other objects. Various color palates are available for these decorative features. Decorative elements may be moved around the surface of a tier, manipulated to change the size and/or color, and/or rotated along three dimensional axes.

Additional tiers may be added by selecting icon 84 or 13, which prompts the pastry design system to provide the functionality of BLOCK 415. The pastry design system displays the GUI in FIG. 11, which allow the user to add a tier by clicking on icon 14. Tier separators can be added between cake tiers by clicking on icon 16.

Once the user has selected a tier and/or separator, e.g., by clicking (with pointing device) on the desired icon on tool panel 103, the selected tier and/or separator is then displayed on cake plate 61 on top of table 60 against background 20a. The user can then begin to decorate or make any changes to the tier stack.

In an exemplary embodiment, the user may add up to 16 tiers 75 and/or separators 100. The tiers 75, when added one after another without any changes will stack symmetrically similar to the tier 75 below it, where the pastry design having the selected number of tiers and the shape associated with each tier is presented to the user via a GUI, such as the one illustrated in FIG. 11.

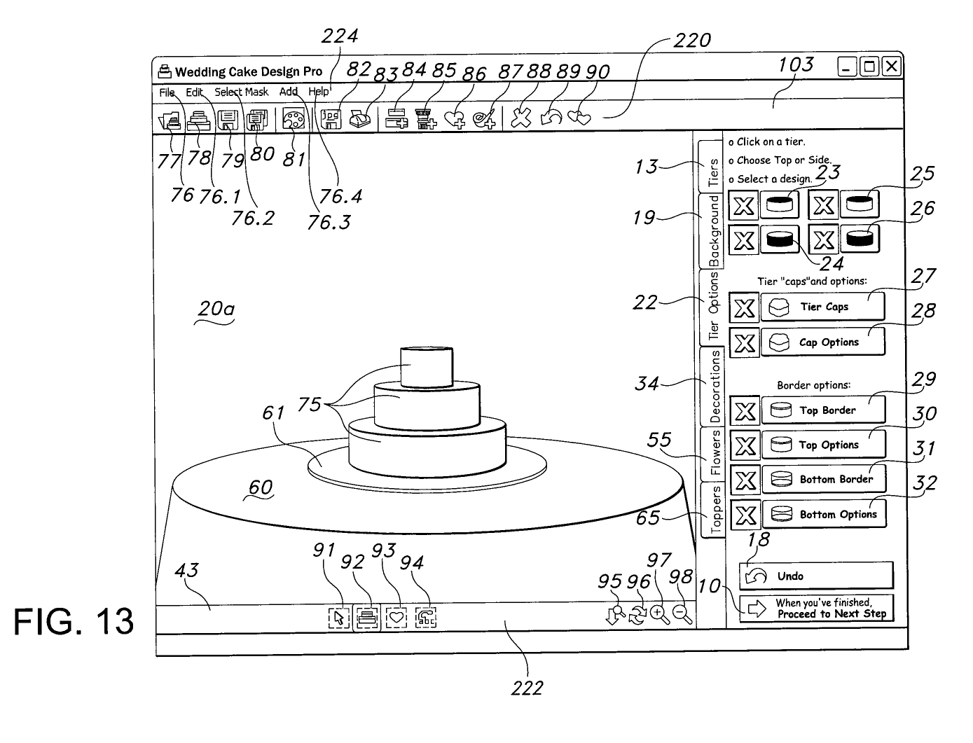

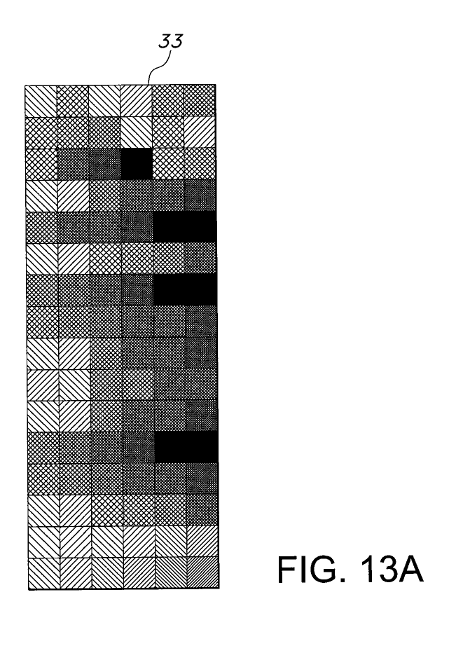

As soon as a tier 75 is placed on cake plate 61, the pastry design system displays the GUI associated with Tiers Options tab 22, as shown in FIG. 13, which provides the functionality of BLOCK 418. The user may add color and/or other decorations via tool panel 103. The pastry design system updates and presents the pastry design responsive to the decoration element inputs received from the user.

If the user selects the tier icon from the icon panel window, a tier is recalled from a sub-directory via the pastry design system application and is placed in the three-dimensional field on the GUI with a small white box appearing around the selected object. The shape of the tier may be changed by the “change tier shape” icon 9 on tool panel 103. The pastry design system application recalls another tier shape, or the newly selected tier shape from the organized sub-directory within the media directory within the system main directory, and places or replaces the selected tier in the three-dimensional GUI field, depending on which icon the user selects.

Tool panel 103 contains the “top borders” icon 29, a “top options” icon 30, a “bottom borders” icon 31, and a “bottom options” icon 32. If the user selects the top or the bottom/border options icons 29-32, the pastry design system opens a color selections window 33 (FIG. 13A) in tool panel 103 for the top and/or bottom borders. “Top border” refers to the border along the top edge of a given or selected tier and “bottom border” refers to the border along the bottom edge of a given or selected tier. These color, object, or pattern options are recalled from the sub-directories as explained above and may be selected and recalled to the desired location on the selected border on the selected tier in the three-dimensional GUI.

Similarly, tier side designs and tier top designs may be added. Selection of icon 23 colors the top of the tier; selection of icon 24 colors the side of the tier; selection of icon 25 applies patterns to the top of the tier; selection of icon 26 applies patterns to the side of the tier; selection of icon 27 applies tier cap style; and selection of icon 28 applies tier cap options. Tier cap styles 27 correspond with the shape of the selected tier. The tier cap style is the cut appearance of the “cap” or overlay. By way of example only, one cap style may have points along the bottom edge and another style may have six rounded “swoops” or “bunting” along the bottom edge. Yet another style may have 8 “swoops” along the bottom edge. Cap “options” may refer to, but are not limited to, the color palate for the tier cap. Another exemplary option may be a patterns in various styles, (e.g., checks, stars, flower print, harlequin, etc).

FIG. 13A is a color option palate 33 for the three-dimensional objects tiers, caps, borders, bouquet builders, beads, bows, and monogram topper. Flowers, leaves, decorations, and some toppers have unique color options. The user can access color palate 33 by selecting “Tier Options” tab 22 from the screen shown in FIG. 13, then selecting either the desired top or side design icon 23-26 or the desired “Border Options” icon 29-32. To access the “Tier Options” tool panel window from tab 22, a tier 75 must first be selected. A cap or border for the selected tier 75 must be selected from icons 27-32, which generates color palate 33 on tool bar 103. The user clicks on the desired color option and the color is applied to the object selected. Alternatively, the user can access color palate 33 from either “Decorations” or “Flowers” tabs 34, 55 by selecting color icon 37. After the desired color is selected, color palate 33 closes and tool bar 103 reverts to the previous screen.

FIG. 12 depicts a GUI that includes background color choices 20 and an “Adjust Lighting” icon 21, which provides the functionality of in BLOCK 420. The environment in which the pastry design is to be displayed may be adjusted. Adjusting background choices 20 will change the background appearance of background 20a. Adjusting slider 21 will change the lighting of both tier stack 75 and background 20a. The background choices may be recalled from the media file 126 located in the .wcdp directory stored on the user's hard drive 121 (FIG. 1).

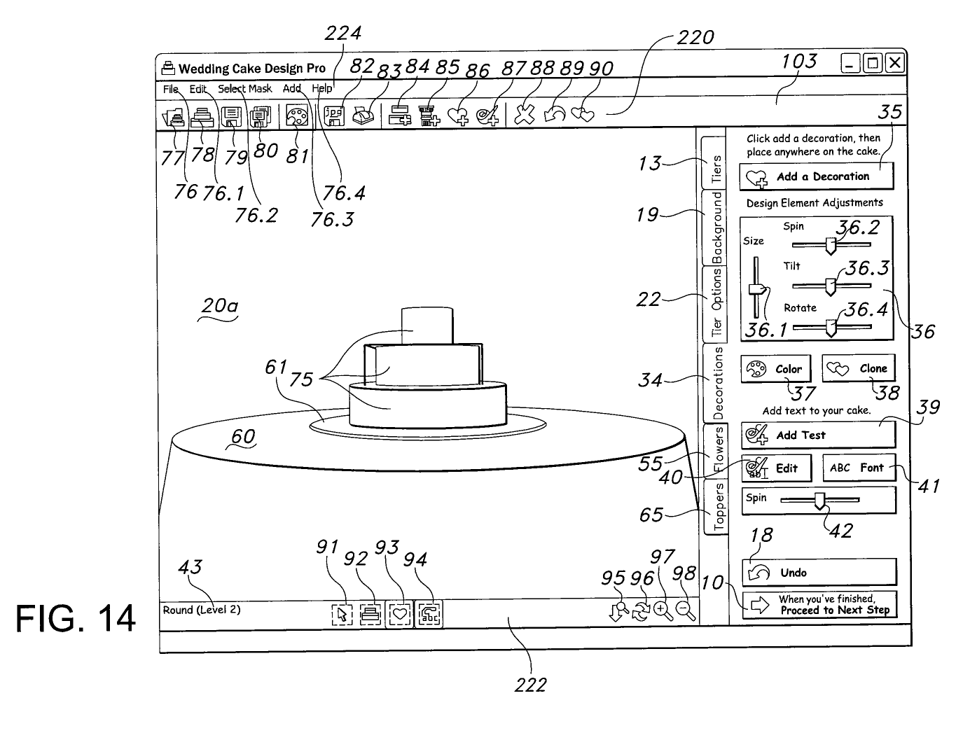

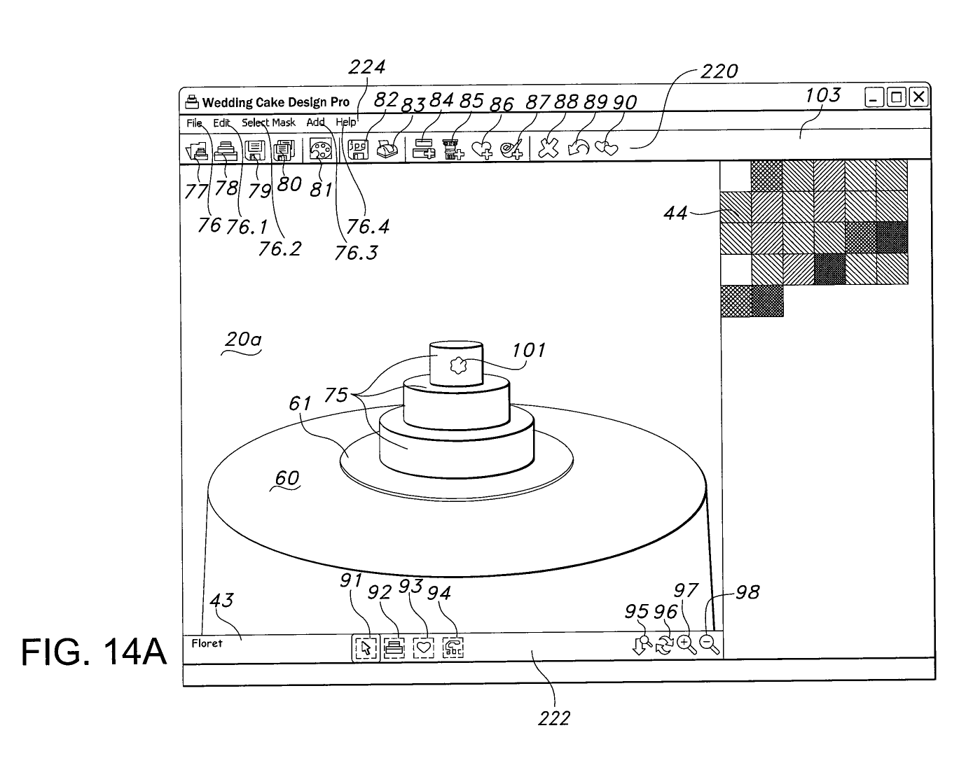

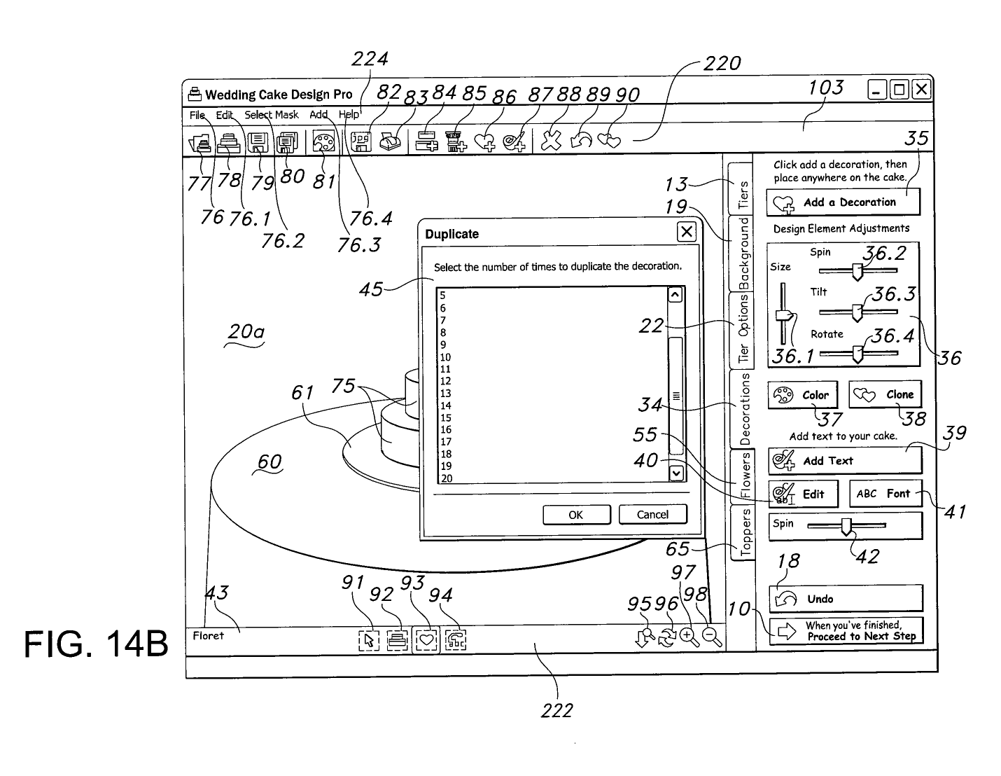

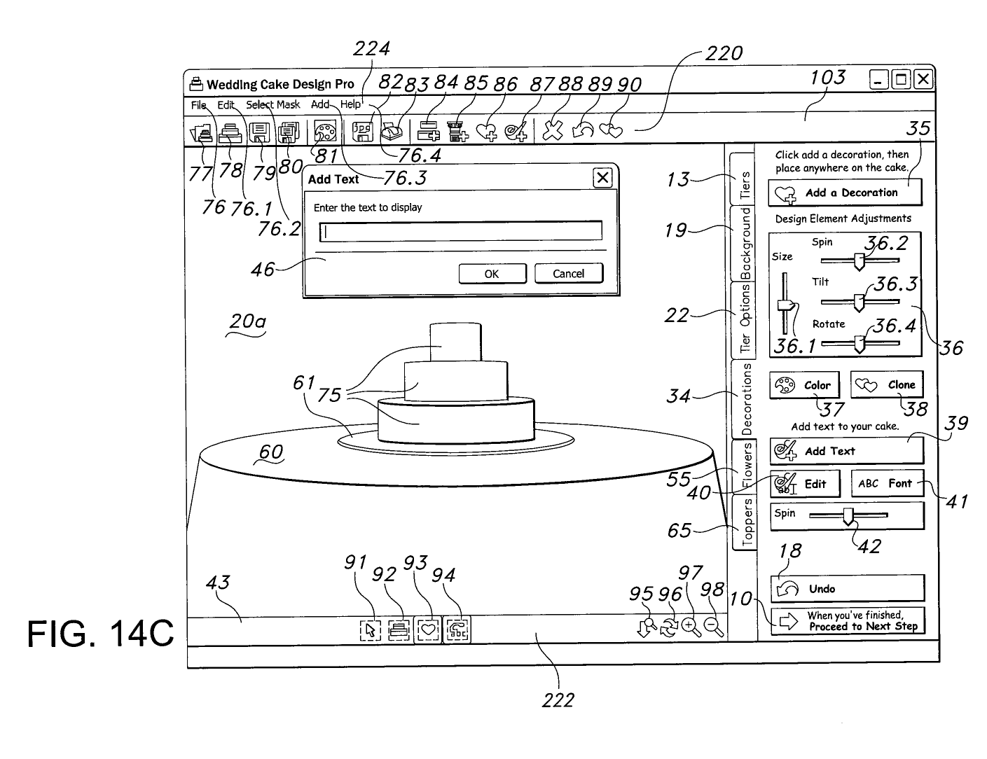

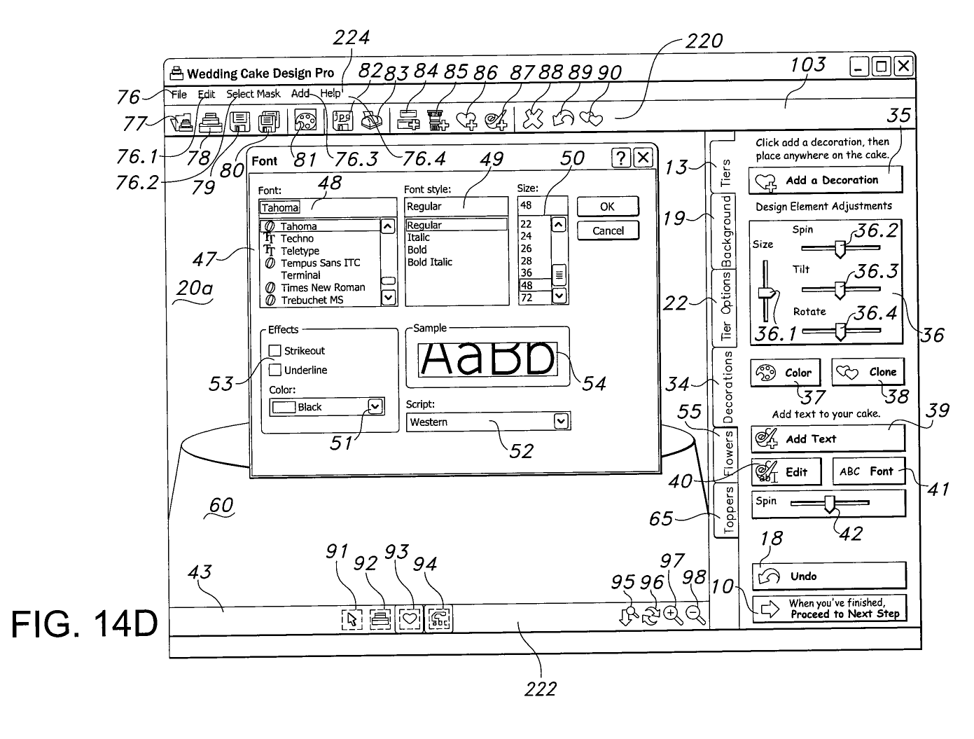

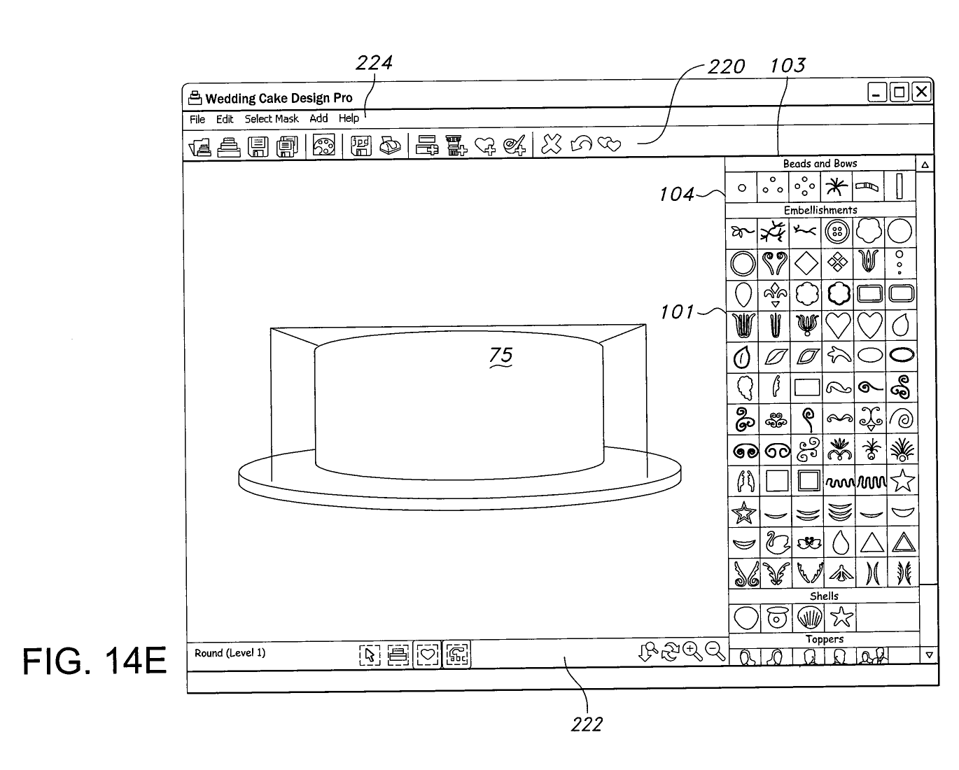

FIG. 14 depicts a GUI associated with the Decorations tab 34 located on the tool panel 103, which provides the functionality of BLOCK 422. An “Add a Decoration” icon 35 is located on tool panel 103. By selecting icon 35 with a pointing device, a decorations option panel 104, shown in FIG. 14E, will appear on tool panel 103. The “Embellishments” shown in tool panel 103 of FIG. 14E are two-dimensional elements that may be added to the selected tier 75, while the remaining design elements are three-dimensional elements. The two-dimensional graphics are a combination of plants and other objects commonly used in the decoration of wedding and specialty cakes. Some of the objects are similar to those which are typically piped out of a pastry bag onto the tiers of a cake.

The decorations may be a combination of three-dimensional and two-dimensional masked graphics with multiple configurable attributes when applied to the tiers. The three-dimensional and two-dimensional graphics and decorations may be manipulated and adjusted for size, color, spin, rotation, number, and tilt. Each tier may be decorated individually with as many or as few design elements as desired.

The three-dimensional graphics include but are not limited to people, plants, inanimate objects, caps, patterns, and animals. These three-dimensional graphics may be placed on a tier by click and drag or drag and drop operations.

The user may select a decoration option by selecting the desired object, dragging the selected object 101 to the tier stack 75, and releasing the object 101 in the desired location. Tool panel 103 then reverts to the appearance of tool panel 103 in FIG. 14.

The user may adjust the size and orientation of that object by selecting the object 102, which results in a white frame surrounding the object. The user may then manipulate sliders 36.1-36.4 for size, spin, tilt, and rotation, respectively, on a “Design Element Adjustment” panel 36 located on tool panel 103.

The user may change the color of the object by selecting the object on the tier stack and then selecting the “Color” icon 37, which changes tool bar 103 to display a decoration color palate 44 shown in FIG. 14A. A color may then be selected and the selected color applied to the desired decoration. After the color is selected, tool bar 103 reverts to tool bar 103 shown in FIG. 14.

The decorations and objects may be “cloned” or duplicated by selecting the object on the tier stack and then selecting the “Clone” icon 38, shown in FIG. 14. This will open up a “Duplicate” dialogue box 45 shown in FIG. 14B. The user may then select the number of times that they wish to duplicate the selected decoration/object by selecting a number within the dialogue box 45 and then selecting “OK.” The object will then be duplicated the selected number of times around the perimeter of tier 75.

FIG. 14C illustrates that the user may add text to the cake by selecting the “Add Text” icon 39 on tool panel 103. When the user selects “Add Text” icon 39, a dialogue box 46 opens 46 against background 20a. The user may then type text into dialogue box 46 and then select “OK.” Text may be placed on a tier after being edited for font, color, size, script, and orientation. Once placed, each decorative feature may be moved or deleted. Predefined shapes, colors, two-dimensional objects, and three-dimensional objects may be located in the systems directory stored locally on the user's computer hard drive.

The user may add text to the design by selecting a decoration tab 34 and then by selecting an icon to add text. The user may enter text in the text field using the keyboard or via conventional copy and paste commands. FIG. 14D illustrates an exemplary font editing dialogue box 47 that will appear after text has been entered into “Enter Text” dialogue box 46 and “OK” is selected. Using font editing dialogue box, the user may then edit the font attributes, such as font 48, font style 49, size 50, color 51, script 52, and effects 53. A sample of the edited font is shown in the sample window 54 of font editing box 47.

While viewing the control selections in a sample window, the user may accept the font parameters and the text created with the various attributes may then be placed on the top or side of the actual tier. A “cross hatch” may appear at the approximate middle of the text to be placed. The user then left clicks the mouse button or left clicks the pad control to drop or place the text in the desired location.

Once the user completes the edit selections, the user selects “OK.” As the user moves the pointing device over the tier, the font and text will become visible. The user then clicks on the tier to drop the text at the desired location. The user may then spin the text on the tier by selecting the text on the tier and then adjusting a “Spin” slider 42 located on tool panel 103.

The user may return to the GUI associated with the decorations tab 34 located on tool panel 103 and edit the text or font by selecting the text on the tier and then selecting the “Text Edit” icon 40, “Font edit” icon 41, or by adjusting the text “Spin” slider 42.

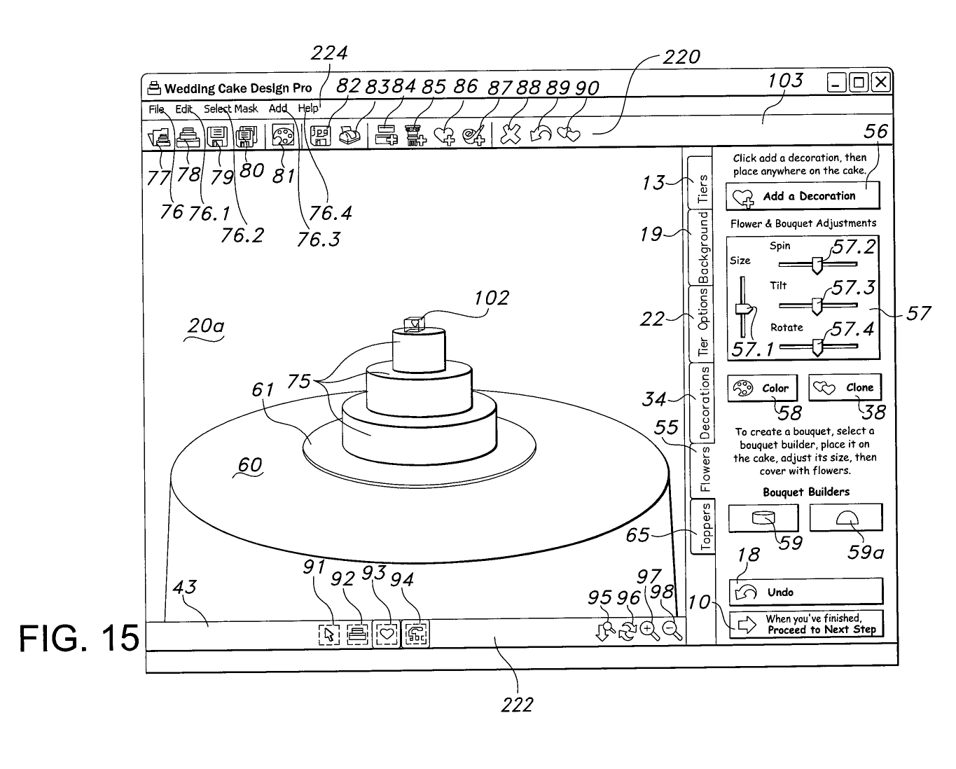

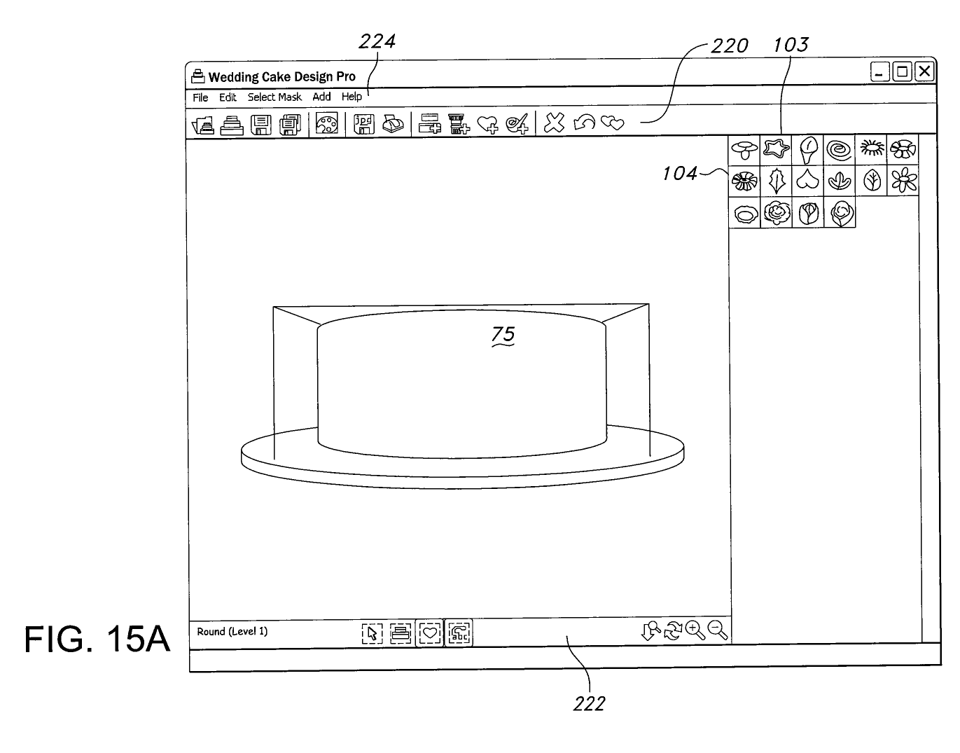

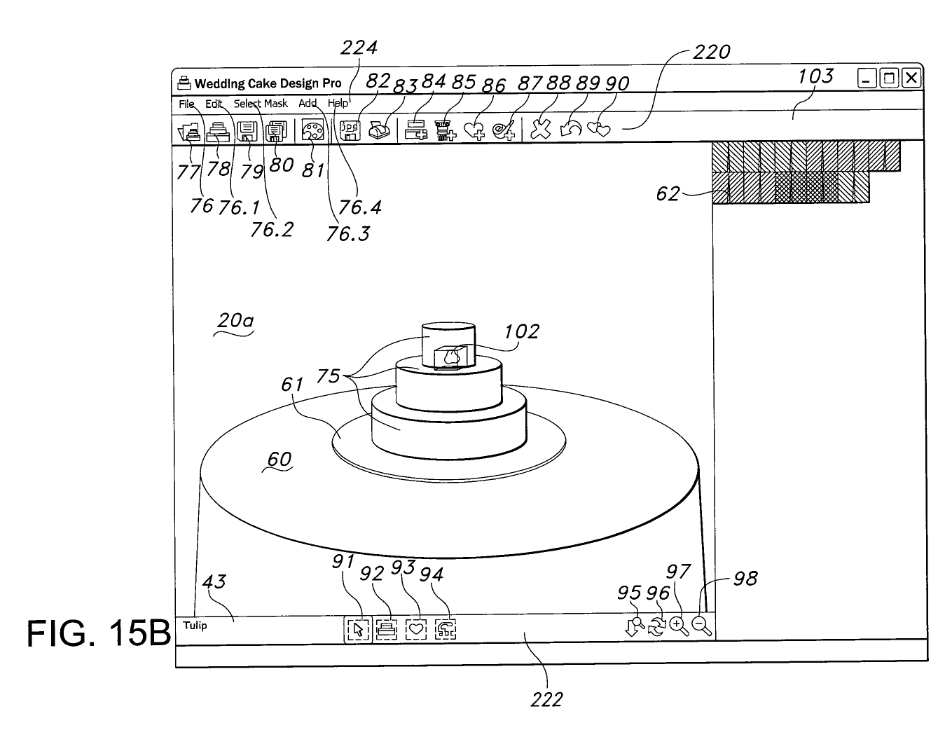

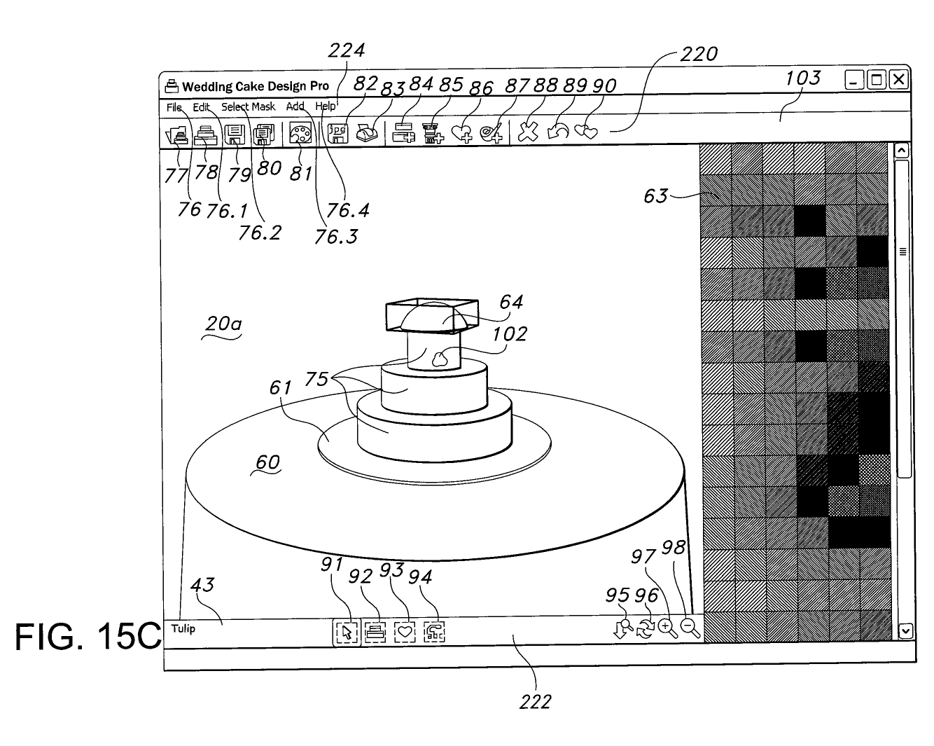

FIG. 15 depicts a GUI associated with the “Flowers” tab 55 located on tool panel 103, which provides the functionality associated with BLOCK 424. The user may add a flower by selecting the “Add a Flower” icon 56 located on tool panel 103. The flower selections window opens in tool panel 103, as shown in FIG. 15A. The user may then select the desired flower 200 by clicking on it and dragging flower 200 to the desired location on the tier stack 75. The user may then place the selected flower 200 in the desired location by dropping flower 200 with a click of a mouse button. Tool panel 103 then reverts to the tool panel 103 shown in FIG. 15.

The user may then adjust the size and orientation of flower 200 by selecting flower 200 and then manipulating the sliders for size, spin, tilt, and rotation 57.1-57.4, respectively on the “Flower and Bouquet Adjustment” panel 57 located on tool panel 103. The selected flower 200 is indicated with a white wire frame 102, as shown in FIG. 15.

The user may change the color of the flower by selecting the flower on the tier stack, then clicking the “color” icon 58, which generates a color palate 62 in tool bar 103, shown in FIG. 15B. The selected color is then be applied to the desired flower. After the color is selected, tool bar 103 reverts to tool bar 103 shown in FIG. 15.

Referring back to FIG. 14, the flowers may be “cloned” or duplicated by selecting the flower on the tier stack and selecting a “Clone” icon 38. A “Duplicate” dialogue box 45, shown in FIG. 14B, will open on the screen. The user may then select the number of times that they wish to duplicate the selected flower by selecting a number within dialogue box 45 and then selecting “OK.” The duplicated flower will then be duplicated the selected number of times around the tier perimeter.

Referring back to FIG. 15 and the flow chart 600 of FIG. 4, “Bouquet Builder” icons 59, 59a are used to build a bouquet. A bouquet builder provides a tool to create a three-dimensional live floral bouquet or a three-dimensional/two-dimensional object/decoration bouquet. A three-dimensional bouquet builder allows the user to build a bouquet on a frame that can be re-sized, tilted, rotated, and removed, leaving only the flowers or objects. A user may optionally color the bouquet builder in order to blend it in with the flowers or other objects on the tier. This feature allows the user to design a three-dimensional bouquet of “live flowers” or objects/decorations and place it on a tier. The “live flowers” simulate actual flowers that a florist may place on the actual cake.

The user may select the frame of the bouquet by selecting the three-dimensional “cylinder” frame icon 59 or the three-dimensional “dome” frame icon 59a. These ions 59, 59a are distinguished by the shape of the icon on the icon itself. If the user selects the “dome” shape icon 59a, a dome shaped frame will appear attached to the pointing device. In STEP 602, the system receives the selection of the frame associated with a selected icon 59, 59a. In STEP 603, the frame is displayed on the GUI. Using the GUI, the user then drags the object to the desired location on the tier stack 75 and clicks to drop the object. In STEP 604, the system provides a display of the selected frame in the desired position.

The bouquet dome or cylinder frame may be colored by clicking on the color icon 58 located on tool panel 103 of FIG. 15. Color palate 63 will appear in tool bar 103, as shown in FIG. 15C. The user may then select a color by clicking on the desired color within the palate, which places that color on the bouquet dome object 64, as shown in FIG. 15C. After the color is selected, tool bar 103 reverts to tool bar 103 shown in FIG. 15. The generated bouquets may be adjusted by using the flower and bouquet adjustments sliders 57.1-57.4.

Decorations, flowers, and objects may be placed on the bouquet builder shapes in the same manner as the tiers. In STEPS 604-606, the system presents a plurality of live floral designs. The user selects a floral design, which is received by the system. The pastry design is then updated with the live floral design.

The bouquet builder frames may be deleted, leaving the placed objects behind, i.e., “floating” above the tiers. In this embodiment, in STEP 608, the system receives the selection to remove the frame. Alternatively, the bouquet builder frames may be colored to blend in with the design. In this embodiment, in STEP 610, the system receives a color selection for the frame. In STEP 612, the user may transmit a command for the system to save the design to memory and/or print out the design on paper.

The lower horizontal tool bar 43 is the object, tier, separator, decoration, flower, and topper name display area. FIG. 15 includes the word “Orchid” to illustrate an exemplary flower selected for addition to tier stack 75.

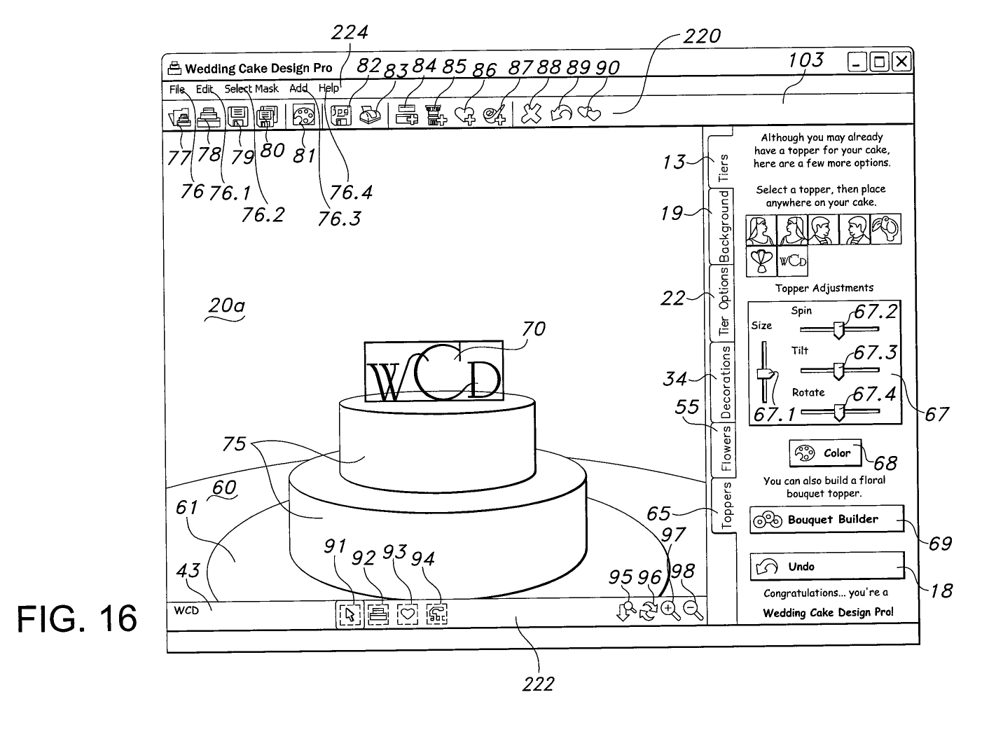

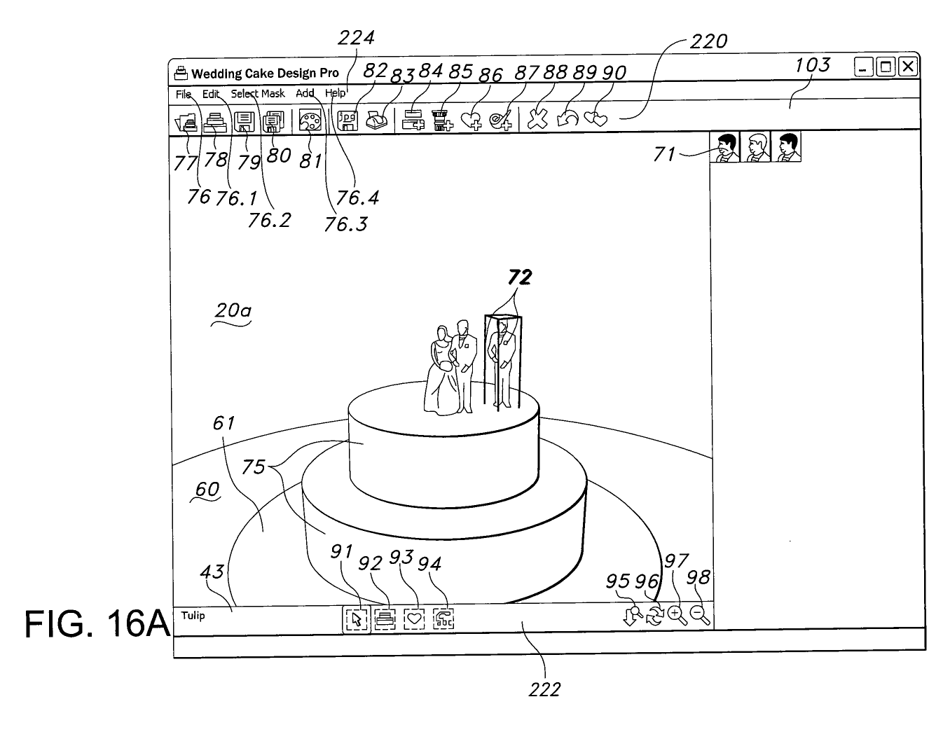

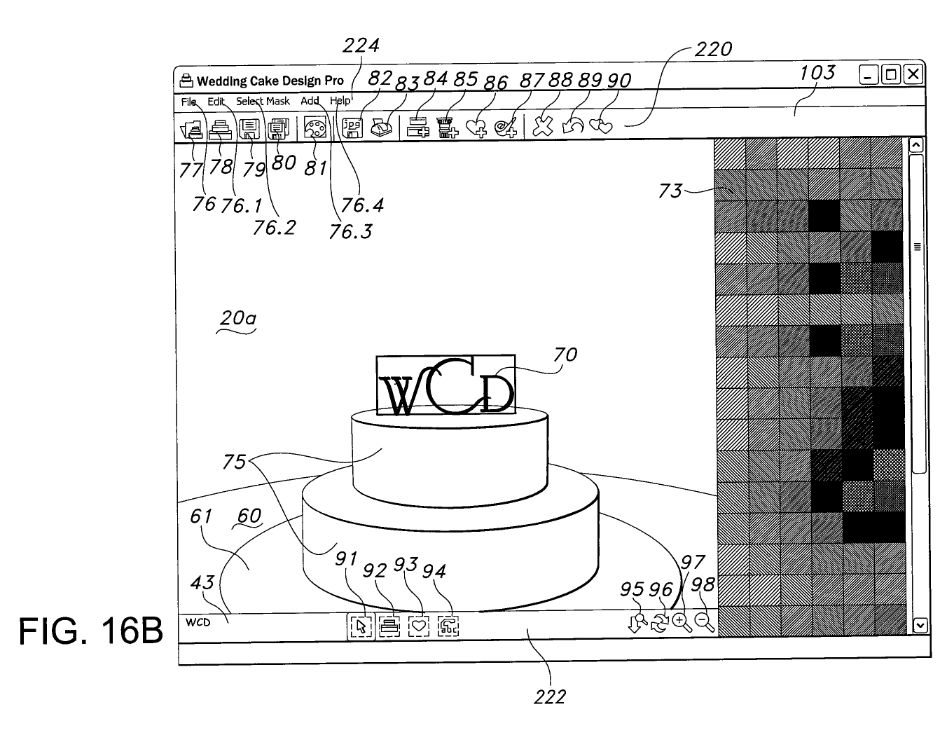

FIG. 16 depicts a GUI associated with a Toppers tab 65, which provides the functionality of BLOCK 426. The user may select various cake toppers using this GUI including, but not limited to people, objects, and monograms using icons 66. The user may then select the desired non-floral topper by clicking on the desired icon 66 and dragging it to the desired location on tier stack 75. The user may then place the selected topper 70 in the desired location, as identified by an exemplary topper “WCD”, by dropping the topper 70 onto the top tier with a click of the mouse button.

The user may then adjust the size and orientation of topper 70 by selecting the topper (noted by a white frame surrounding topper 70) and then manipulating the sliders 67.1-67.4 for size, spin, tilt, and rotation on the “Topper Adjustments” panel 67 located on tool panel 103.

The user may change the color of topper 70 by selecting topper 70 on tier stack 75, then clicking “Color” icon 68, which generates topper color palate 63, which appears on tool panel 103, shown in FIG. 16B for the topper objects that are not people.

Referring back to FIG. 16, if people are selected, the user may change their appearance by selecting “Color” icon 68, which generates a people shade palate 71 on tool panel 103, as shown in FIG. 16A. The user may then select a shade by clicking on the desired shade palate 71, with the result appearing on topper 72 located on tier stack 75.

The toppers may be “cloned” or duplicated by selecting a desired topper 72 on tier stack 75, then clicking on “Clone” icon 38. “Duplicate” dialogue box 45, shown in FIG. 14B, opens up. The user may then select the number of times that they wish to duplicate the selected topper 72 by clicking on a number within “Duplicate” dialogue box 45 and then clicking “OK.” The duplicated topper will then be duplicated the selected number of times around the perimeter of tier stack 75.

Referring back to FIG. 16, the three-dimensional “Bouquet Builder” icon 69 is located on tool panel 103. Selection of icon 69 switches the user to the flowers GUI shown in FIG. 15. The user may then select the desired bouquet builder as described above.

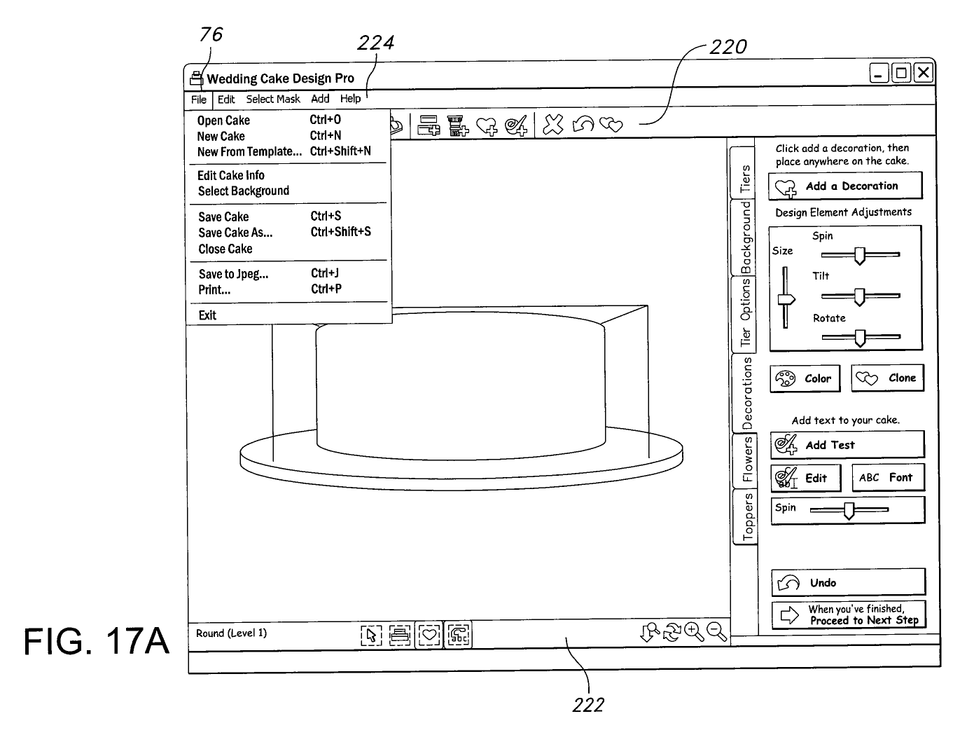

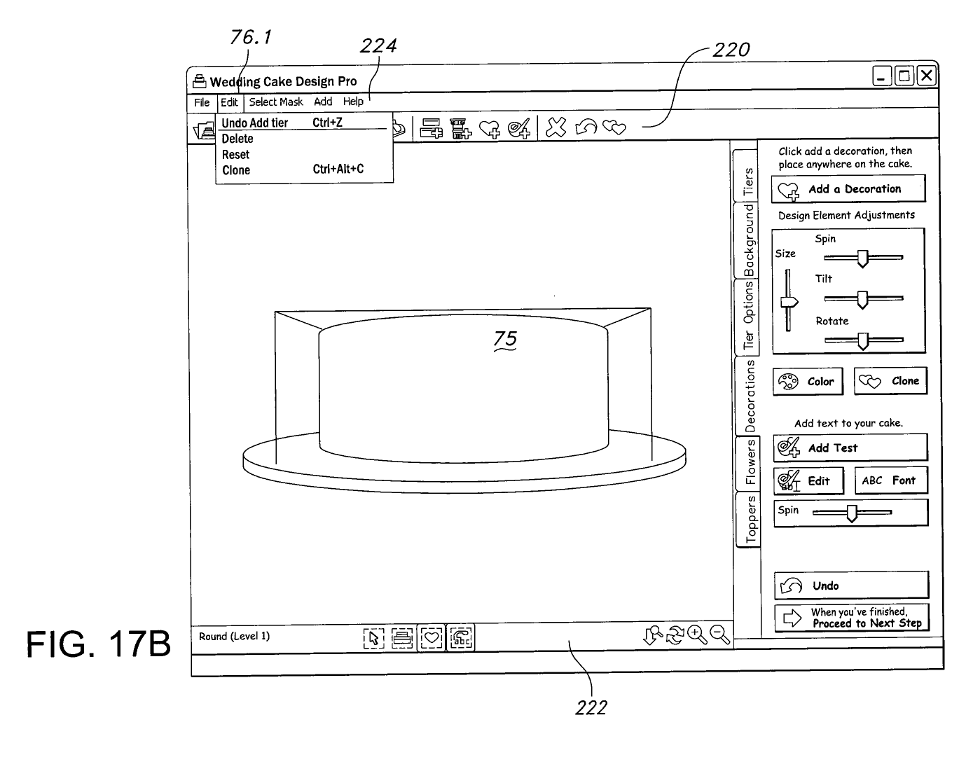

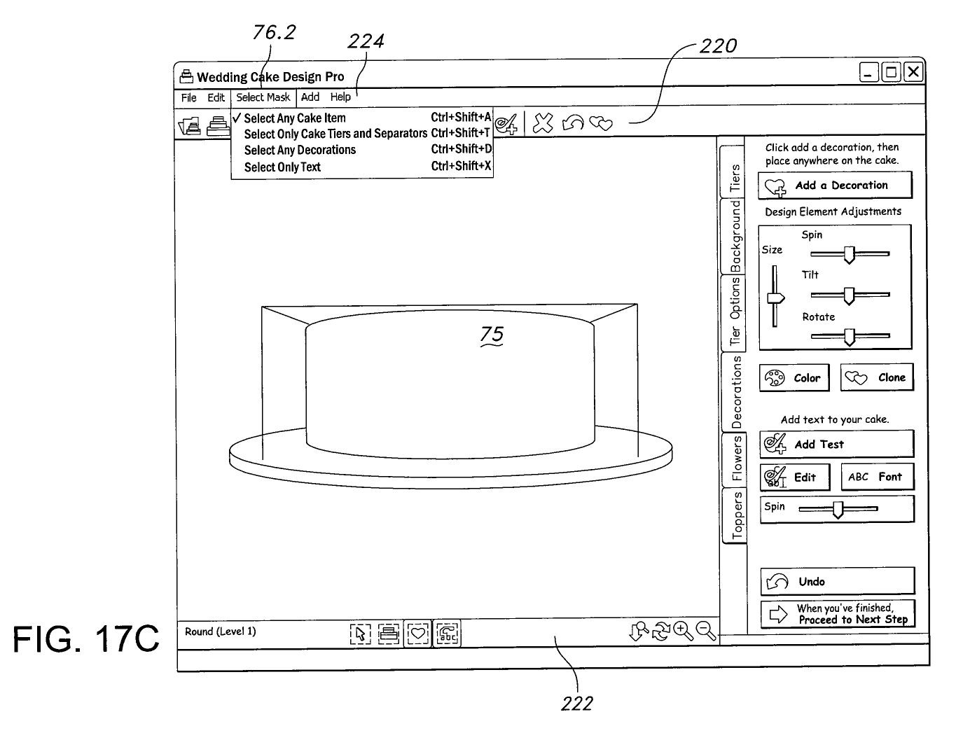

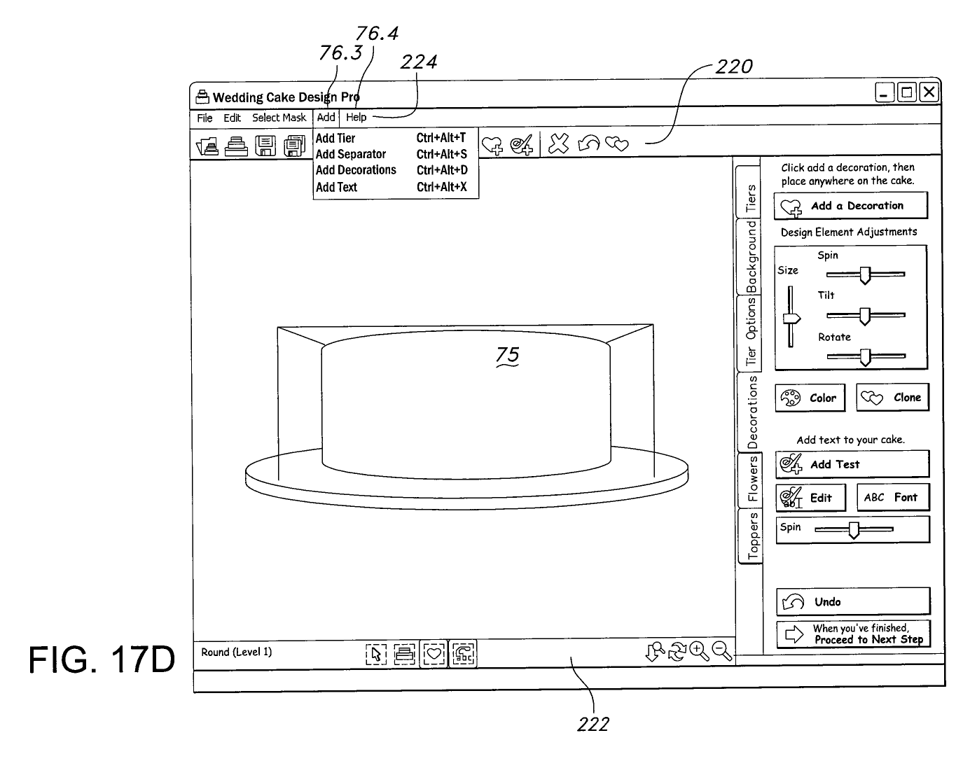

FIGS. 6-13, 14-17D illustrate a command bar. Clicking on “File” icon 76 in the GUIs depicted in FIGS. 6-13, 14-17D opens a drop-down box as shown in FIG. 17A. Selecting an “Open Cake” command takes the user to dialogue box 4, shown in FIG. 6, to open a cake design that has been saved as a .wcd file. Selecting a “New Cake” command will start the user with an empty cake plate 61, shown in FIG. 7. Selecting a “New from Template” command takes the user to dialogue box 4, shown in FIG. 6, to open a pre-designed cake design that has been saved as a wedding cake template (.wct) file.

A printing interface offers the user the ability to gather demographic data regarding a special event. The data may be, but is not limited to, date, time, location of event, florist, number of guests, bride and groom names. This information may be associated with and printed out on the design print-out for easy reference. This feature may be useful to both the customer and the pastry chef/baker. Selecting the “Edit Cake Info” command will open a “Wedding Information” demographic dialogue box 99, shown in FIG. 18.

Selecting a “Select Background” command will open the background selection choices on tool panel 103, shown in FIG. 12. Selecting a “Save Cake” command will save the user's cake design as a .wcd file in a default directory or wherever the user directs the save using the save dialogue box. Selecting a “Save Cake As” command will save the user's cake design as a .wcd file in the default directory or wherever the user directs the save using the save dialogue box. Selecting a “Close Cake” command will close the user's current cake design.

Selecting a “Save to Jpeg” command allows the user to save the work as a .jpg file in the default directory or wherever the user directs the save dialogue box. Selecting a “Print” command will print out the contents of the user's display screen, and selecting an “Exit” command will exit the program.

Files may be imported and exported to and from the system (see BLOCKs 440 and 442). An import function allows the user to import certain file types (which can include graphics interchange format (gif)/.jpg/.png files) that are used by the system as decorations. This allows the user the freedom to create his/her own proprietary files for use within the system.

An export function allows the user to export the cake specifications to certain file formats which may include but are not limited to .pdf/extensible markup language (xml)/tab-delimited. These file formats also support active hypertext markup language (html) links with which the user may direct to a specific web address. For example, the user may use an active html link to access an external website, such as a florist, caterer, etc.

“Collection” (not shown) allows the user to select collections of decorations in order to give the user more organizational control. “Edit group mode” allows the user to create and store object collections as well as manipulate those objects and collections that can be recalled for use at another point in the design process. For example, a plurality of flowers may be individually selected and grouped together to form a flower bunch. The flower bunch may be saved as an object and cloned or recalled later as a single object.

Referring to FIG. 17B an “Edit” command drop down box 76.1 contains the choices of “Undo,” “Delete,” “Reset,” and “Clone.” Selecting the “Undo” icon will undo the previous task or selection. By way of example only, if a tier is added to the cake plate, the “Undo” icon will display as “Undo Add tier,” which allows the user to undo or remove the tier selection.

Selecting the “Delete” icon will delete a selected object. By way of example only, if a tier is on the cake plate and then is selected (white wire frame surrounds tier) the “Delete” icon will delete the selected object. Selecting the “Reset” icon will reset the original viewing perspective of the cake under construction in the work area. Selecting the “Clone” icon will clone a selected object or decoration. This functions as “Clone” icon 38 located on the decoration and flower tool panels (FIGS. 14, 14B-14D, 15).

A “Select Mask” command 76.2, shown in FIG. 17C, allows the user to select any item, only tiers and separators, only decorations, or only text for editing. This feature helps the user select desired objects during very complex cake builds. For example, once tiers 75 are on plate 61, the user may work on tiers 75 in “Select Any Cake Item” mode, “Select Only Cake Tiers and Separators” mode, “Select Only Decorations” mode, or “Select Only Text” mode. The specific masks only allow the user to select the item in that mode category. For example, the “Select Tier Only” mode allows only adjustments to tiers.

An “Add” command drop down box 76.3, shown in FIG. 17D, allows the user to add a tier, text, decoration, or separator. A “Help” icon 76.4 is also shown in FIG. 17D. Selecting “Help” will open up a searchable help document. The “Help” command is common in software applications and is understood by those skilled in the art.

An upper horizontal tool bar includes icons 77-90 that provide short cuts for operating the system. Icon 77 is the “Open a Saved Cake” icon, which allows the user to recall a saved cake from the user storage directory. Icon 78 is the “Open New Cake” icon short cut, which allows the user to start on a new cake design. This icon will empty cake plate 61 in background 20a, as shown in FIG. 7.

Icon 79 is the “Save Cake” icon shortcut, which allows the user to easily save their work as a re-loadable .wcd file. Icon 80 is the “Save Cake As” icon short cut, which allows the user to save a cake as a re-loadable .wcd file and also allows for expansion in order to later save as other file formats. Icon 81 is a short cut to the “Background Color” selection panel, which generate the screen shown in FIG. 12. The user may then change the background of background 20a as described above.

Icon 82 is the “Save As a .JPG file” format short cut, which saves the user's work as a .jpg file in the default directory. In one embodiment, when icon 82 is selected, the system holds the image in memory at approximately a 4096×4096 resolution while the image is being rendered. After rendering the .jpg file, the system reverts back to its original screen resolution. This resolution capture has two basic settings: approximately 4096×4096 resolution and approximately 512×512 resolution. The higher resolution may be turned on via an internal code setting, which the user may not be able to manipulate. This features allows system computers 120 that can only display up to a 1024×1024 resolution to display the .jpg on display device 134.

Icon 83 is the “Print” icon short cut, which allows the user to easily print the contents of the display area. Icon 84 is the “Add a Tier” short cut, which generates the screen shown in FIG. 11 and adds a tier to the cake plate or to the existing tier stack in background 20a.

Icon 85 is the “Add a Separator” short cut, which adds a separator to the cake plate or to the existing tier stack in the Background 20a. Icon 86 is the “Add a Decoration” short cut, which adds a decoration after selection of a decoration to the existing tier stack in background 20a. Icon 87 is the “Edit Text” short cut, which allows the user to easily edit the text that they have placed on their work.

Icon 88 is the “Delete” short cut, which allows the user to delete a selected design element by selecting/highlighting the desired element with a “white frame” and then clicking icon 88 to delete the selected element. Icon 89 is the “Reset” short cut, which resets the selected and manipulated objects back to the original starting position. Icon 90 is the “Clone” short cut, which allows the user to easily clone selected objects.

FIGS. 6-13, 14-17D show the short cuts 91-98 of lower horizontal tool bar 43, which may be selected in BLOCK 432. Icon 91 is the “Select any object mode” short cut, which allows the user to select any object in the background 20a. Icon 92 is the “Select tiers only” short cut, which allows the user to only select tiers and separators within work/display area 20a.

Icon 93 is the “Select only decorations” short cut, which allows the user to select only decorations in background 20a. Icon 94 is the “Select only text” short cut, which allows the user to only select text that is located on a tier stack with in background 20a.

Icon 95 is the “Step back feature” short cut, which allows the user to take a look at their work from a “stepped back” position. Icon 96 is the “Tilt and rotate” short cut. The user may alternatively achieve this effect by right clicking and holding down on the right mouse button and scrolling the mouse, resulting in spin and tilt of the cake design in any direction.

A zoom-in icon 97 gives the user a closer view of their work in the work/display window. A zoom out icon 98 gives the user a look at their work for a farther away perspective, looking at the work in Background 20a.

Further, as shown in FIGS. 20, 22-26, and 28, the system may include “Library” tab 330. Tab 330 may provide access to the functionalities of any of “Add User Decoration,” “Export Bouquet,” and “Import Bouquet” from BLOCK 428 (shown in FIG. 2)

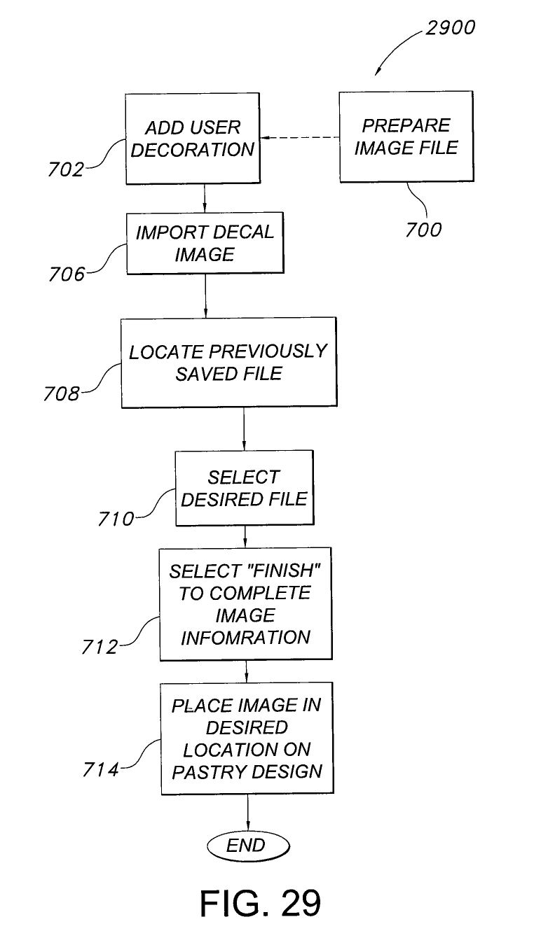

FIG. 29 depicts a flow chart 2900 of exemplary steps for adding a decoration image to the design. To facilitate description, the steps of flow chart 2900 will be described with reference to FIGS. 20-25A. In STEP 700, the user may first prepare the image file. This preparation can be done using other known graphic programs, such as, for example, Microsoft Paint, available from Microsoft® or Adobe graphics programs, available from Adobe®. Optionally, in an exemplary embodiment, the background of the image to be imported is not a color that is contained in the image that is to be imported (i.e., if the image to be imported is a violin and the violin is brown and black, then the background can be any color, as long as it is not brown or black). The image may then be saved to a desired location, such as, for example hard drive 121.

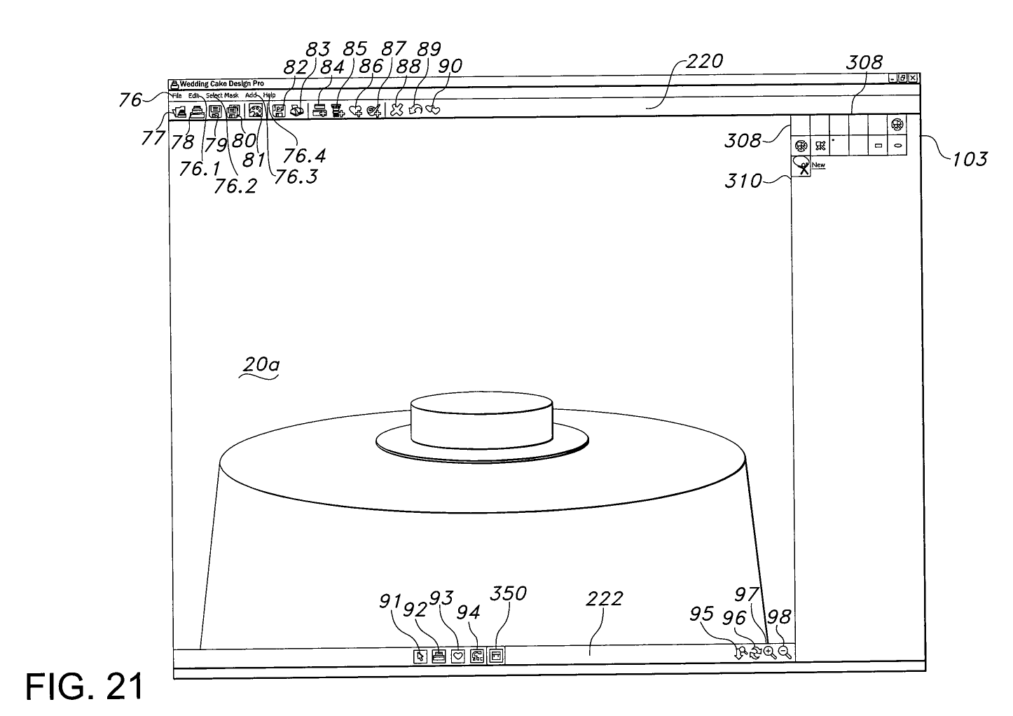

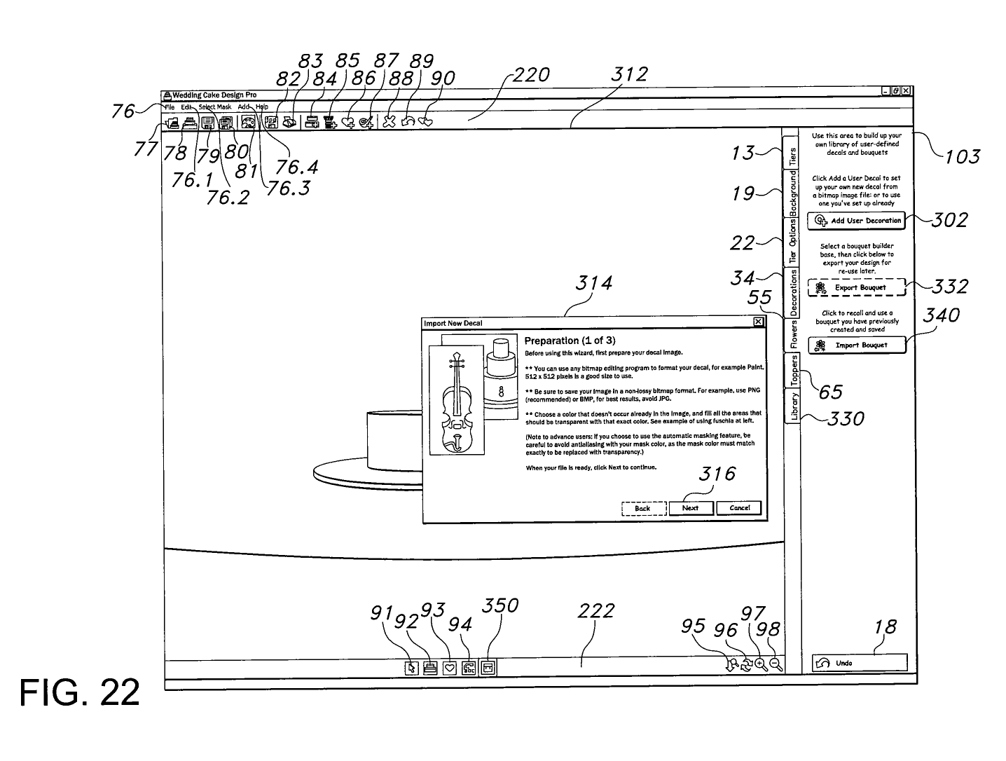

Once the user has prepared the image, in STEP 702, the user selects the “Add User Decoration” button 302 on tab 330, which allows the user to import a user-created bitmap (.bmp) or .png file and then have this image available as a decal for the user to use while decorating the pastry. These images may be stored on the user's hard drive 121 (shown in FIG. 1) at a default location, i.e., “C: \Documents_and_Settings\Name\Application_Data\Wedding_Cake_Design_Pro\m edia\meshes\decorations\decals.” Selection of button 302 results in the GUI illustrated in FIG. 21 in tool panel 103, which displays saved user decorations 308 and the underlined word “New” 310 after the last user decoration 308. Clicking on the underlined word “New” 310 in FIG. 21 results in the system displaying the GUI of a first decal importation screen 312, as shown in FIG. 22. Decal importation screen 312 includes a text box 314 that provides instructions to the user on how to prepare a decal image for importation. The user follows the instructions for preparing the decal image for importation. Optionally, STEP 700 may be omitted if the image file has already been prepared.

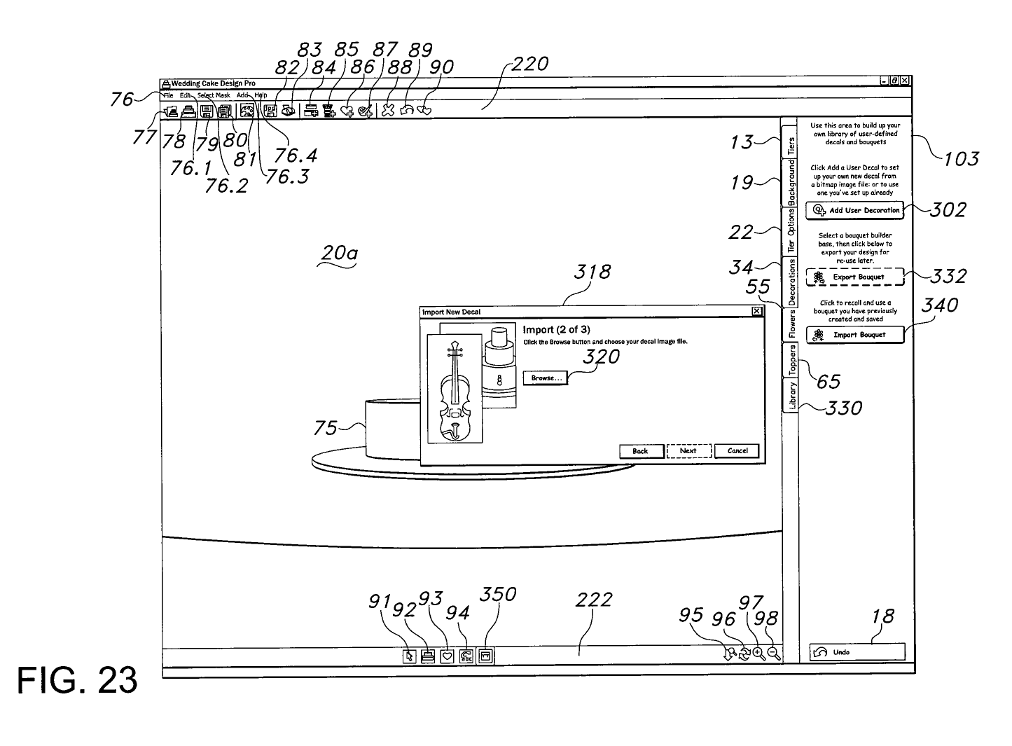

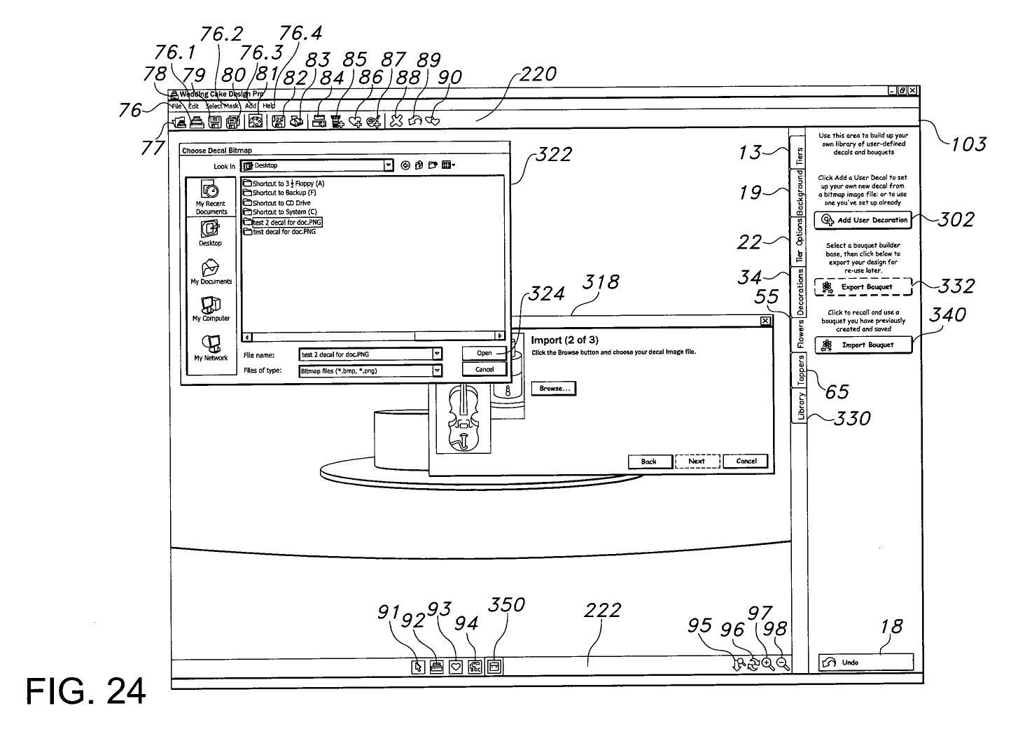

In STEP 706, clicks a “Next” button 316 to import the decal image. Selection of the “Next” button 316 results in the GUI shown in FIG. 23, which displays a dialogue box 318. In STEP 708, the user selects “Browse” button 320 from dialogue box 318 in order to locate the desired, previously saved file. Selection of “Browse” button 320 results in the system displaying the GUI shown in FIG. 24, which displays dialogue box 322. Dialogue box 322 allows the user to search through hard drive 121 to locate a previously saved file. In STEP 710, once the user has selected the file that he/she desires to import, the user selects the “Open” button 324 on dialogue box 322. The system then processes the selected file by creating a decal folder and places the image file and the associated control files (such as .wcd, rich text format (.rti), .cmi, texture, and material files) in the proper directory for recall by the user.

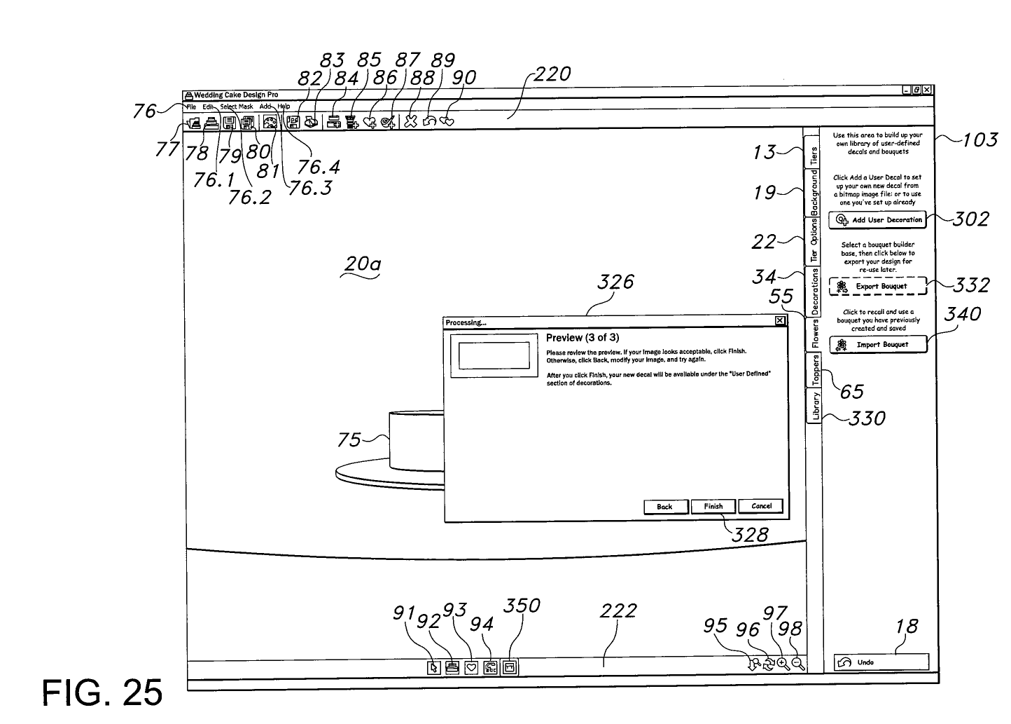

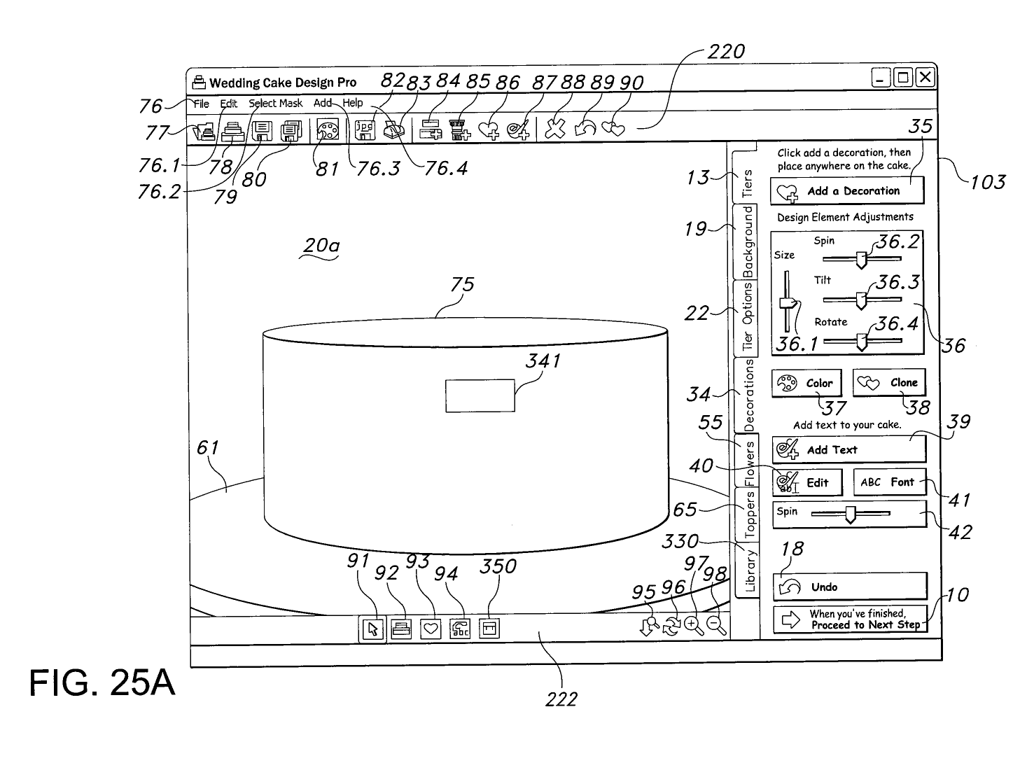

Selection of the desired decal image results in the system displaying the GUI shown in FIG. 25, which provides a “Preview” of the selected decal in a dialogue box 326. In STEP 712, the user may then select “Finish” button 328 in order to complete the importation of the image.

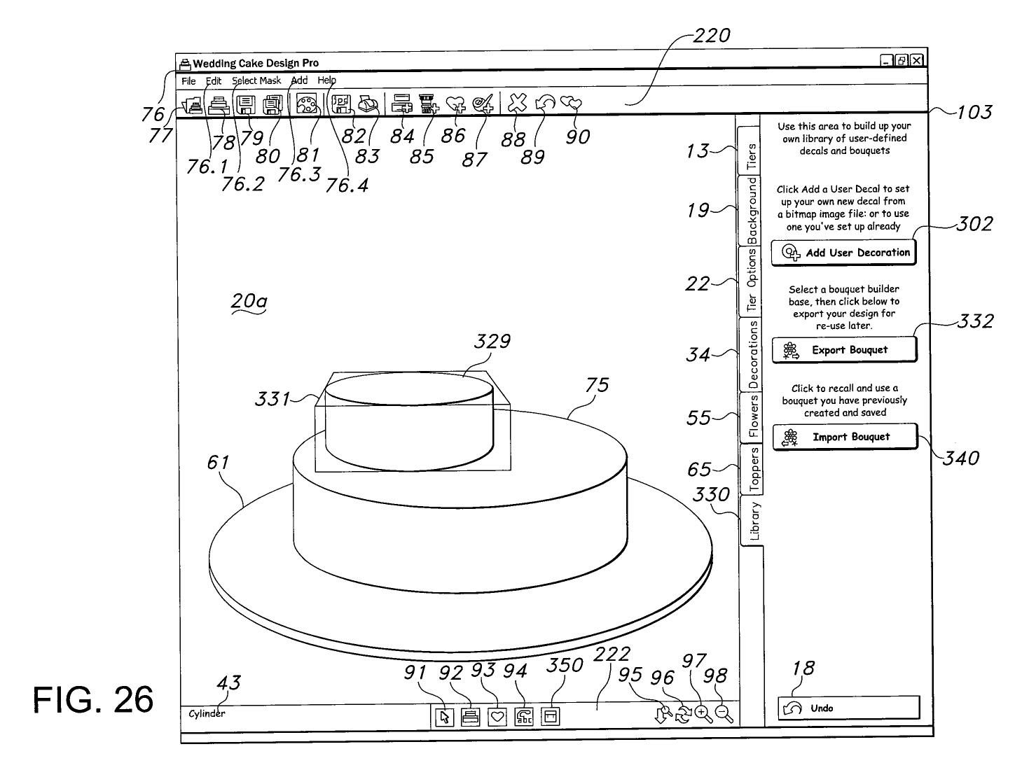

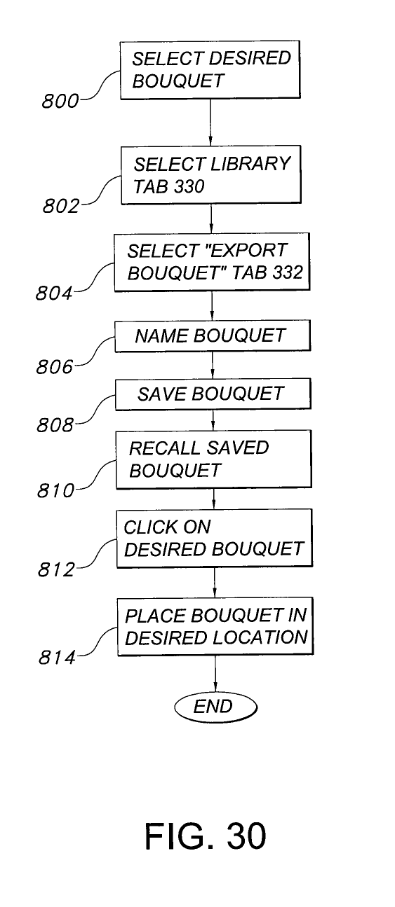

The user-created image is now available for selection by selecting the “Add User Decoration” button 302 on tool panel 103. Selection of the “Add User Decoration” button 302 results in the system displaying the GUI shown in FIG. 21, allowing the user to select an image by clicking on the desired icon 308 on control panel 103. Clicking of the desired icon 308 results in the system displaying the selected image attached to the end of the mouse pointer (not shown) on the screen. In STEP 714, the user may move the image by moving the cursor control to the desired location on the tier 75 or other desired location and then clicking on the mouse to drop the image 341 onto the desired location. The image may be further manipulated by clicking on the “Decorations” tab 34 and manipulating the image 341 as desired. FIG. 25A illustrates an image 341 having been placed onto the side of cake tier 75. Additionally, the user may build a bouquet as described above and with reference to FIGS. 26-28 and 30 and save the bouquet for later use. In order to save the bouquet, in STEP 800, the user selects a desired bouquet by clicking on the bouquet 329, which has been generated as discussed above, generating a white wire frame 331 around the selected bouquet 329, as illustrated in the GUI shown in FIG. 26.

In STEP 802, the user then selects “Library” tab 330 and in STEP 804 then selects the “Export Bouquet” tab 332. Selection of the “Export Bouquet” tab 332 results in the system displaying the GUI shown in FIG. 20, which includes a dialogue box 303, where, in STEP 806, the user may then name this particular bouquet. After naming the bouquet, in STEP 808, the user then may select the “OK” tab 334 to save to bouquet or the “Cancel” tab 336 to delete the bouquet. When the user selects “OK” tab 334, the bouquet is saved to the user's hard drive 121 in a default location, such as, for example, C:\Documents and Settings\User\Application Data\Wedding Cake Design Pro\User Bouquets.

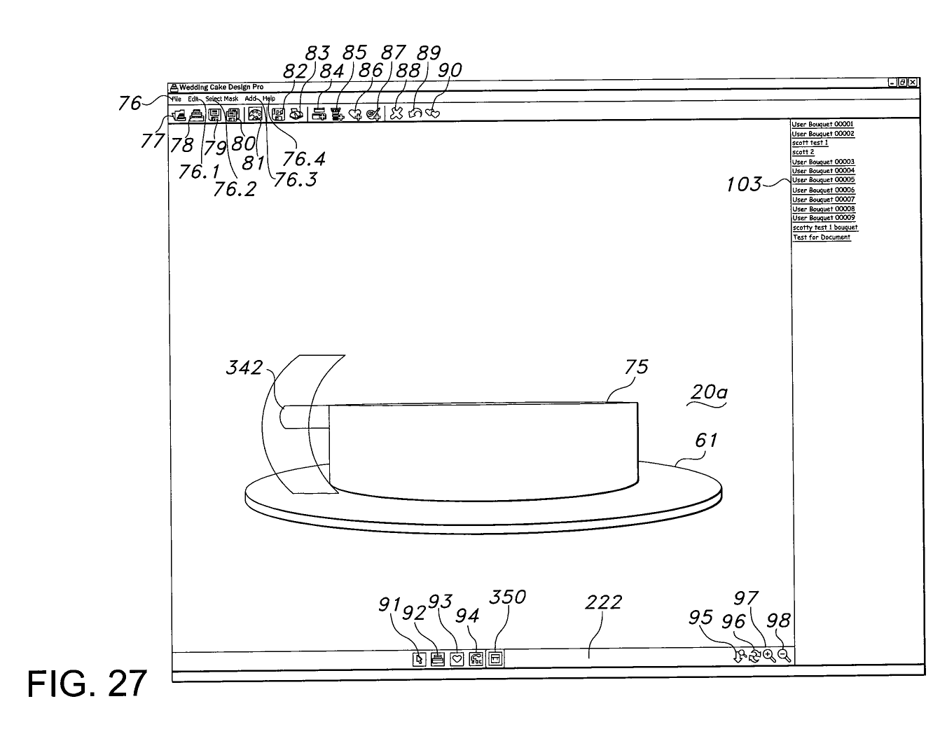

In STEP 810, the user may recall the newly saved bouquet or any other saved bouquets for repeated use by selecting the “IMPORT BOUQUET” tab 340 shown on the GUI in FIG. 20. The GUI changes to the GUI shown in FIG. 27, in which includes tool panel window 103 displays all of the saved bouquets. In STEP 812, to access a saved bouquet, the user may then click on the name of the desired saved bouquet. In STEP 814, the selected bouquet 342 appears and the user is then able to place the bouquet 342 on the cake tier 75 in the desired location. After the bouquet 342 is in place, the user may edit and/or add to the bouquet as described above.

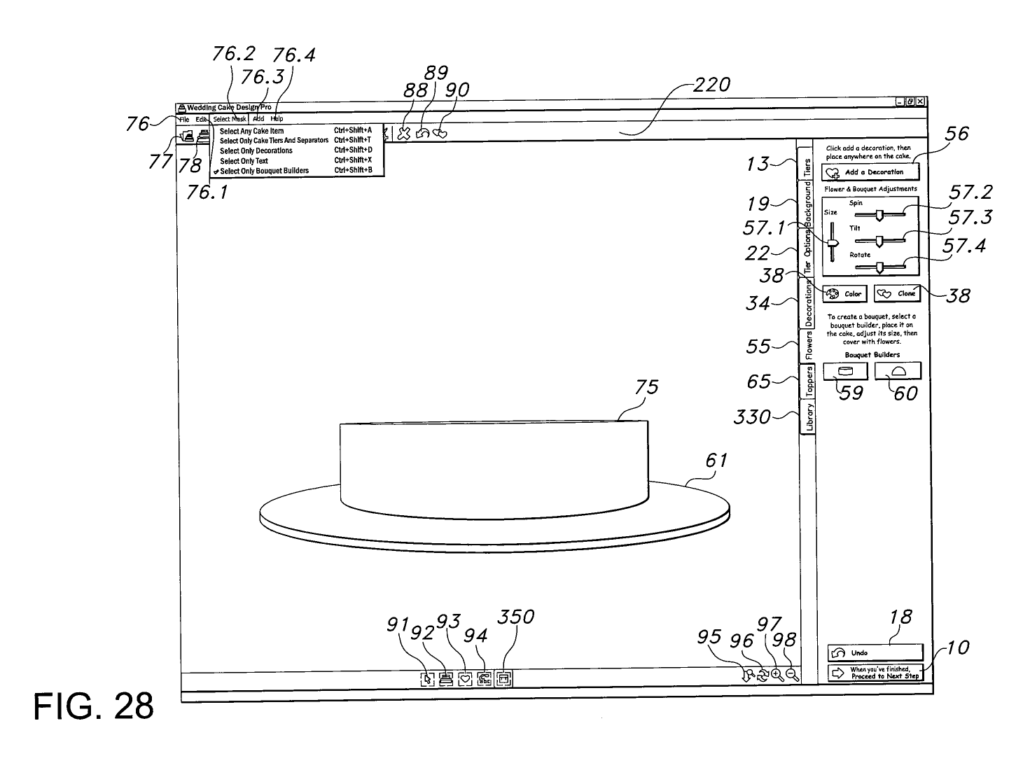

In order to quickly identify bouquets inserted into displayed design, a “Select Only Bouquet Builders” shortcut 350 may be located on lower horizontal tool bar 222. The “Select Only Bouquet Builders” shortcut 350 is similar to the “Select Any Object Mode” shortcut icon 91 or the “Select Only Tiers” shortcut icon 92, described above. Shortcut 350 makes it easier for the user to select only the bouquet builder when saving a custom bouquet. Further, a “Select Only Bouquet Builders” option may be available from dropdown box 76.2, as shown in FIG. 28.

FIG. 3 depicts a flow chart 500 of exemplary steps performed by the pastry design system. At STEP 502, a tier selection that defines a number of pastry tiers is received. The tier selection may be received via the GUIs described above. In an exemplary embodiment, the tier selection may be received in at least two ways, e.g., from a beginner user using the process described above with reference to blocks 410 and 411 and the GUI depicted in FIG. 7 or from a more experienced user using the process described above with reference to block 415 and the GUI depicted in FIG. 11.

At optional STEP 504, a separator selection is received. The separator selection may be received via the GUIs described above. The separator selection may be received via the GUIs described above. In an exemplary embodiment, the separator selection may be received in at least two ways, e.g., from a beginner user selecting from predefined separator styles using the process described above with referenced to block 414 and the GUIs depicted in FIGS. 8-10 or from a more experience user using the process described above with reference to block 415 and the GUI depicted in FIG. 11.

At STEP 506, a shape selection is received for each of the tiers selected in STEP 502. The shape selection may be received via the GUIs described above. In an exemplary embodiment, the shape selection may be received in at least two ways, e.g., from a beginner user who selects a tier shape from a plurality of tier shapes for application to all tiers such as described above with reference to the GUIs depicted in FIGS. 8-10 or from a more experienced user who selects a tier shape on a tier by tier basis using the process described above with reference to block 415 and the GUI depicted in FIG. 11.

At STEP 508, a pastry design based on the selected number of tiers from STEP 502 and the selected shape(s) from STEP 506, and optionally the selected separator(s) from STEP 504, are presented. The pastry design may be presented by a GUI such as the one depicted in FIG. 11 using display device 134 (FIG. 1). It will be understood by one of skill in the art that this may be an iterative process in which additional tier selections shape selections and/or separator selections may be received throughout the design process with the presented pastry design continuously being updated to represent the additional selections.

At STEP 510, decoration element inputs corresponding to one or more tier options and/or decoration elements are received. The decoration element inputs may be received via the GUIs described above. In an exemplary embodiment, the decoration element inputs may be received from a user using the processes described above with reference to blocks 418 and 420 and the GUIs depicted in FIGS. 13, 13A, 14, and 14A-E.

At STEP 512, the presented pastry design is updated responsive to the decoration element inputs received at STEP 510. It will be understood by one of skill in the art that this may be an iterative process in which additional decoration element inputs may be received throughout the design process with the presented pastry design continuously being updated to represent the additional decoration element inputs.

At STEP 514, the updated pastry design is stored. The updated pastry design may be stored to the hard drive 121 of computer 120 (FIG. 1) and/or stored in a conventional buffer, e.g., prior to display on display device 134 (FIG. 1).

At STEP 516, the updated pastry design is presented, e.g., on display device 134 or by printing device 132 (FIG. 1). In an exemplary embodiment, the user may select to present the design in a 2-dimensional format (e.g., see cake layers 75 in GUI of FIG. 14) or in a 3-dimensional format (e.g., see cake layers 75 in GUI of FIG. 14A).

Additional exemplary steps will now be described.

At STEP 518, rotation instructions for rotating a presented pastry design are received and the presented pastry is rotated in response to the rotation instructions. The rotation instructions may be received via the GUIs described above. In an exemplary embodiment, the rotation instructions may be received from a user using the processes described above with reference to block 430 and the GUIs depicted in FIGS. 7-13, 14, 14A, 14E, 15, 15A-C, and 17A-D.

At STEP 520, rotation instructions for rotating one or more decoration elements are received, selected decoration elements are rotated in response to the rotation instructions, and the presented pastry is updated with the rotated decoration elements. The rotation instructions may be received via the GUIs described above. In an exemplary embodiment, the rotation instructions may be received from a user using the processes described above with reference to blocks 422 and 430 and the GUIs depicted in FIGS. 15, 15B, 15C, 16, 16A and 16B.

At STEP 522, event information associated with the pastry design is received and the pastry design is displayed with the event information. In an exemplary embodiment, the event information may be displayed on a print out of the pastry design, e.g., on the pastry design depicted in FIG. 19. The event information may be added using the process described above with reference to block 452 and may be printed on the pastry design by printing device 140.

At STEP 524, a plurality of live floral designs are presented, a selection is received for one of the presented live floral designs, and the pastry design is updated with the selected floral design. The selection of the floral design may be performed using the GUIs described above. In an exemplary embodiment, the floral designs are selected using the processes described above with reference to blocks 424 and the GUIs depicted in FIGS. 15 and 15A-C. Additional details are described with reference to the flow chart depicted in FIG. 4.

At STEP 526, a color adjustment is received for the environment (e.g., the background, plate, and/or lighting) in which the pastry design will be displayed and the environment is updated in response to the color adjustment. The color may be adjusted using the GUIs described above. In an exemplary embodiment, the color of the environment is adjusted using the processes described above with reference to block 420 and the GUI of FIG. 12.

At STEP 528, a topper design is received for placement on top of the top tier of the pastry design and the pastry design is updated with the topper design. The topper design may be selected using the GUIs described above. In an exemplary embodiment, the topper design is created using the processes described above with reference to block 426 and the GUIs depicted in FIGS. 16, 16A, and 16B.

One or more of the steps described above may be implemented in software that controls a computer. This software may be embodied in a computer readable medium, for example, a magnetic disc, an optical disc, a memory card, or essentially any tangible computer readable medium.

An exemplary embodiment of a pastry design system according to the present invention may include all or some of the following features, which are not necessarily all-inclusive:
a. the ability to design a wedding or specialty cake with very little computer skill;
b. the ability to design a wedding or specialty cake with no pastry/baking skill;
c. the ability to design a wedding or specialty cake with no artistic training;
d. a step by step approach to designing a wedding or specialty cake;
e. the ability for an experienced user to build and decorate a cake from nearly unlimited view points;
f. the ability to save his/her cake and decoration work and recall that cake and decoration work at a later date and continue where the user previously ceased their construction;
g. the ability for pastry chefs and bakers to design and show their customers exactly what they will be getting in the form of a real wedding or specialty cake;
h. the ability for the customer to show the pastry chefs and bakers exactly what the customer would like to have constructed for his/her special event;
i. expandability, in that, the system itself may be enhanced and expanded upon by adding additional two-dimensional and three-dimensional graphic objects;
j. eliminates the need to create any decorative objects, which may be stored in a directory on the user's computer hard drive, for example;
k. may be installed locally on the user's computer;
l. uses three-dimensional computer graphic technology, allowing the user to view their creation from any angle (spin, tilt, rotate);
m. provides a bouquet builder that allows users to construct a three-dimensional floral or object bouquets on a tier within their design;
n. allows text to be edited for font, color, style, script, size, spin, and placed on the cake tiers by the user;
o. has multiple computer file sharing methods, such as a .wcd file and a .jpg file;
p. allows the user to capture demographic data at the time of print out and fix that data to the printed image;
q. can be updated with new attributes and/or new features and decorations;
r. provides a value added service that pastry professionals may provide to their clients at the time of consultation via print out or file sharing;
s. allows the user to select from a number of predetermined languages for ease of use;
t. allows the user to import certain file types (which can include gif/jpg/png) that the system may implement as two-dimensional decals to be used in the decoration of the three-dimensional cake;
u. allows the user to export cake and decoration specifications (in an editable format) to certain file formats which can include pdf/xml/tab-delimited file formats;
v. allows the user to “drop in” or install decoration collections; and/or
w. allows the user to create and store object collections as well as manipulate those objects and collections that can be recalled for use at another point in the design process.

Although the invention is illustrated and described herein with reference to specific embodiments, the invention is not intended to be limited to the details shown. Rather, various modifications may be made in the details within the scope and range of equivalents of the claims and without departing from the invention.

We claim:

1. A method for creating a pastry design comprising the steps of:
receiving a tiers selection defining a number of pastry tiers;
receiving a shape selection for each of the selected number of pastry tiers;
presenting a pastry design based on the tiers selection and the shape selection for each of the number of pastry tiers;
receiving decoration element inputs corresponding to one or more decoration elements;
updating the presented pastry design with the one or more decoration elements responsive to the decoration element inputs;
preparing an image for display;
receiving image inputs corresponding to the image;
updating the pastry design with the image; and
storing the updated pastry design to a storage medium.

2. The method according to claim 1, further comprising the steps of:
saving the image to a predetermined location; and
importing the image from the predetermined location.

3. A system for creating a pastry design comprising:
means for receiving a tiers selection defining a number of pastry tiers;
means for receiving a shape selection for each of the selected number of pastry tiers;
means for presenting a pastry design based on the number of tiers selection and the shape selection for each of the number of pastry tiers;
means for receiving decoration element inputs corresponding to one or more decoration elements;
means for updating the presented pastry design with the one or more decoration elements responsive to the decoration element inputs;
means for preparing an image for display;
means for receiving image inputs corresponding to the image;
means for updating the pastry design with the image; and
means for storing the updated pastry design to a storage medium.

4. The system according to claim 3, further comprising:
means for saving the image to a predetermined location; and
means for importing the image from the predetermined location.

5. A method for designing a computer-generated floral bouquet comprising the steps of:
a) receiving a frame selection identifying a frame;
b) presenting the identified frame in a desired position on a video display;
c) receiving a floral selection identifying a floral design;
d) storing the floral bouquet design to a storage medium;
e) recalling at least one of a plurality of user-generated floral designs from the storage medium; and
f) adding the at least one of the plurality of user-generated floral designs to a pastry design.
